(19) United States
(12) Patent Application Publication
(10) Pub. No.: US 2007/0299708 A1
(43) Pub. Date: Dec. 27, 2007

(54) FIELD OF INTEREST ANALYSIS METHOD, TOOLS AND SYSTEM

(75) Inventors: Andrew J. Ouderkirk, Woodbury, MN (US); Robert R. Kieschke, Woodbury, MN (US); Michelle M. Bellanca, Stillwater, MN (US); Margaret A. Hartfel, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/425,443

(22) Filed: Jun. 21, 2006

(51) Int. Cl. G06Q 10/00; G05B 19/418; G07G 1/00

(52) U.S. Cl. 705/8; 705/1; 705/10

(57) ABSTRACT

Systems, methods, and tools are provided for analysis of one or more fields of interest for use, for example, in making decisions and/or allocating resources. For example, a field of interest involving a technology platform may be analyzed to allocate research and development resources, value potential acquisitions, etc. One or more analysis tools such as data recordation structures may be employed.

### BACKGROUND OF THE INVENTION

The present invention relates generally to analysis tools and systems/methods relating thereto (e.g., technology mapping tools, strategic planning tools, life planning tools, etc.). Such analysis may be beneficial, for example, for optimizing the process of technology identification, business development, and successful commercialization thereof (e.g., the management of technology platforms), or, for example, for use in the identification and analysis of information related to one or more other seed ideas or concepts in a field of interest (e.g., products for a business, acquisitions for a business, career planning, and/or the education field).

With the substantial amount of information available from various sources, including the knowledge and/or know-how of individuals and/or organizations, decisions related to such information (e.g., management decisions, engineering decisions, business decisions, project initiatives, or investment decisions) are complex due, for example, to the need to sort through such information, identify the relevance of such information, and/or otherwise analyze such information. A coordinated management of the analysis of such information is generally needed to arrive at an informed decision, solution, etc. In many cases, information may be readily available for analysis; however, in other cases, information may only be the result of and/or occur during an analysis of such information (e.g., generation of ideas, thoughts, etc. that occur during the analysis).

Various traditional methods of evaluating information for making decisions with respect to projects, initiatives, and investments for a commercial, or non-commercial, entity start with the compilation of lists of projects or other information. For example, in a commercial setting, such projects may be placed in some prioritized manner based on return of investment, etc., without the rigor of a business model methodology. Further, for example, in a non-commercial setting such as an in an educational institute, such projects may be placed in a prioritized manner based on growth in enrollment or some other factor without a rigorous analysis.

Increasingly, organizations have used various systematic approaches in the analysis of information to arrive at decisions. For example, Six Sigma methodologies have been used to increase the rigor of business management processes.

Further, for example, various processes and tools have been described to integrate a business unit's projects into performance measurements, management functions, and business models. One example of such tools is described in U.S. Patent Application Publication No. U.S. 2003/0083912 A1 published 1 May 2003, and entitled “Optimal resource allocation business process and tools.” As described therein, for example, optimal resource allocation business processes include a set of characterization criteria, prioritization techniques, and analytic tools, such as project matrixes, project summary charts, individual project worksheets, project listings, and e-business process and attribute listings.

However, methodologies such as Six Sigma and other information analysis tools are generally inadequate when applied in various situations, for example, when applied to the development of a technology platform (e.g., a platform of products and/or processes that are related to a particular field of interest). For example, although methodologies such as Six Sigma provide common language and systematic methodology, support data driven project selection, and provide focus on commercialization and on creating robust products that may satisfy validated client needs, such methodologies also have weaknesses. For example, such methodologies are designed to evaluate products rather than technology platforms, the criteria used in evaluations performed generally favor technology projects in established and well-understood market spaces, and, generally, only provide tools designed to assess technology value within a product line, but not typically across product lines. Further, for example, such methodologies have difficulties in accessing unarticulated needs (e.g., evolution of a technology) and do not build upon assumptions toward satisfying an unarticulated need.

In other words, there are various tools available to analyze information (e.g., identify relevant information, sort through a substantial large amount of information, etc.), and there are also various tools available that utilize such analysis for making one or more decisions (e.g., resource allocation, management decisions, quality process improvement decisions, etc.). However, with respect to the development of technology platforms, most conventional techniques use technology roadmaps that focus on sequencing research and development investments. Such techniques only deal with articulated needs and are typically only one dimensional (e.g., one technology migration). The focus on such research and development investments leads one away from developing a broader view of a technology platform related to a field of interest. Further, this one-dimensional view of needs or problems to be addressed can limit the scope of the solution set such that it can only take advantage of a single competency of the organization or individual.

Further, such conventional techniques may overvalue certain outcomes over uncertain outcomes. This bias tends to lead to incremental and predictable results. In situations where maintaining strategic advantage is important, such as new business development or military planning, techniques that lead to results that can be predicted by competitors or enemies are clearly disadvantageous.

### SUMMARY OF THE INVENTION

One or more embodiments of the present invention may be beneficial when dealing with various fields of interests (e.g., technology platforms for a business, acquisitions for a business, career planning, and/or the education field) to create a platform of linked elements (e.g., technology, products, product form, brand, channel, business processes, etc.). In one or more embodiments, the present invention may provide for the definition of a technology platform of linked elements related to a field of interest that is capable of providing a sequence of product launches that provide a steady stream of cash flow sufficient to self-fund ongoing research and development investments for the technology platform. One or more of the various tools described herein may provide for the charting of multiple pathways that lead a user to develop and define a series of incremental product introductions into multiple markets. For example, such pathways may provide valuable technology, process, and market learning that enable effective development of future products related to the field of interest.

One embodiment of a method for use in analysis of a field of interest according to the present invention includes providing two or more data recordation structures. Each of the two or more data recordation structures is configured to receive information and corresponds to one of a plurality of topic categories related to the field of interest. Each of the two or more data recordation structures include a primary data description region for receiving a hierarchical structure of dominant and subservient descriptions related to the corresponding topic category, a generational data description region for receiving information relating to an increasing level of advancement over time of one or more of the subservient descriptions in the hierarchical structure, a differentiating data description region for receiving information relating to at least one or more differentiating attributes of subservient descriptions provided in the primary data description region and/or relating to at least one or more differentiating attributes of information provided in the generational data description region, and a rating region for use in rating at least one or more characteristics of information in the differentiating data description region.

The method further includes recording information for a first topic category in a first data recordation structure of the two or more data recordation structures (e.g., the information for the first topic category comprises at least descriptions having a relationship that can be arranged in the hierarchical structure of the primary data description region thereof), recording information for a second topic category in a second data recordation structure of the two or more data recordation structures based on information provided for the first topic category (e.g., the information for the second topic category comprises at least descriptions having a relationship that can be arranged in the hierarchical structure of the primary data description region thereof), and recording information in one or more of the generational data description regions, the differentiating data description regions, and the rating regions for one or more subservient descriptions recorded in the hierarchical structure of the first and second data recordation structures.

In one or more embodiments of the method, the method further includes using at least the first and second data recordation structures to generate a summary guide for the field of interest based at least on the ratings provided in the rating region of at least one of the first and second data recordation structures.

Further, in one or more embodiments of the method, each of the two or more data recordation structures is configured to receive information related to at least one of products, articles, or processes in the field of interest, wherein each of the two or more data recordation structures corresponds to one of a plurality of topic categories (e.g., the plurality of topic categories comprise markets for products in the field of interest, articles in the field of interest, and processes related to the field of interest). In such embodiments, the three data recordation structures may be provided (e.g., each of the at least three data recordation structures correspond to one of three topic categories including markets for products in the field of interest, articles in the field of interest, and processes related to the field of interest, respectively).

In one embodiment of the method, the hierarchical structure of the primary data description region for at least one data recordation structure includes dominant and multiple levels of subservient descriptions related to the corresponding topic category (e.g., the multiple levels of subservient descriptions including a most subservient description). In such an embodiment, information relating to at least one or more differentiating attributes of the most subservient descriptions provided in the primary data description region and/or relating to at least one or more differentiating attributes of information provided in the generational data description region may be provided in the differentiating data description region.

In one or more embodiments of the method, at least a market data recordation structure is provided that can be populated with industry, market, and client segment descriptions in a primary data description region of the market data recordation structure; at least an article data recordation structure may be provided that can be populated with one or more family descriptions, one or more genus descriptions for each family, and one or more species descriptions for each family in a primary data description region of the article data recordation structure; and/or at least a process data recordation structure may be provided that can be populated with function descriptions indicative of what functions one or more processes are to achieve, operation descriptions indicative of general groups of processes that can carry out such functions, and specific process descriptions indicative of transformation outcomes which fall within the general groups of processes.

In another method for use in analysis of a field of interest, the method includes providing at least three data recordation structures (e.g., each of the at least three data recordation structures correspond to one of at least three topic categories including markets for products in the field of interest, articles in the field of interest, and processes related to the field of interest, respectively). Each of the at least three data recordation structures includes a primary data description region for receiving a hierarchical structure of dominant and one or more levels of subservient descriptions related to the corresponding topic category (e.g., the one or more levels of subservient descriptions including a most subservient description), a generational data description region for receiving information relating to an increasing level of advancement over time of one or more of the most subservient descriptions in the hierarchical structure, a differentiating data description region for receiving information relating to at least one or more differentiating attributes of the most subservient descriptions provided in the primary data description region and/or relating to at least one or more differentiating attributes of information provided in the generational data description region, and a rating region for use in rating at least one or more characteristics of information in the differentiating data description region.

Further, the method may include recording information for a first topic category in a first data recordation structure of the at least three data recordation structures (e.g., the information for the first topic category includes at least descriptions having a relationship that can be arranged in the hierarchical structure of the primary data description region thereof), recording information for a second topic category in one or more other data recordation structures of the at least three data recordation structures based on information provided for the first topic category (e.g., the information for the second topic category comprises at least descriptions having a relationship that can be arranged in the hierarchical structure of the primary data description region thereof), and recording at least information of one or more potential products that may be introduced over time in the generational data description region of the data recordation structure corresponding to the markets for products in the field of interest. Yet further, the method includes subjectively rating the overall degree of potential interest of clients in the rating region of the data recordation structure (e.g., data recordation structure corresponding to the markets for products in the field of interest) based at least on the client descriptions in the primary data description region of the data recordation structure (e.g., data recordation structure corresponding to the markets for products in the field of interest) and based on the information of one or more potential products that may be introduced over time in the generational data description region of the data recordation structure (e.g., data recordation structure corresponding to the markets for products in the field of interest).

In one embodiment of the method, the method further includes using at least the rating region of the data recordation structure corresponding to the markets for products in the field of interest to generate a summary guide for the field of interest.

Yet further, in one or more embodiments if the methods described herein, the method is a computer assisted method implemented using at least one computer apparatus. In another embodiment, the two or more data recordation structures are implemented using multiple worksheets. For example, the method may include using at least the first and second data recordation structures to complete a summary worksheet for the field of interest based at least on the ratings provided in the rating region of at least one of the first and second data recordation structures; at least the summary worksheet and one or more of the multiple worksheets are integrated for exchange of information therebetween.

A system to collect information for use in analysis of a field of interest is also described. The system includes two or more data recordation structures, wherein each of the two or more data recordation structures is configured to receive information (e.g., each of the two or more data recordation structures corresponds to one of a plurality of topic categories related to the field of interest). Further, each of the two or more data recordation structures includes a primary data description region configured to request a hierarchical structure of dominant and subservient descriptions related to the corresponding topic category, a generational data description region configured to request information relating to an increasing level of advancement over time of one or more of the subservient descriptions in the hierarchical structure, a differentiating data description region configured to request information relating to at least one or more differentiating attributes of subservient descriptions provided in the primary data description region and/or relating to at least one or more differentiating attributes of information provided in the generational data description region, and a rating region configured to request ratings for at least one or more characteristics of information in the differentiating data description region.

In one or more embodiments of the system, the system further includes a summary guide for the field of interest configured to be completed based at least on the ratings provided in the rating region of at least one of the first and second data recordation structures.

Further, in one more embodiments of the system, each of the two or more data recordation structures is configured to receive information related to at least one of products, articles, or processes in the field of interest. Each of the two or more data recordation structures corresponds to one of a plurality of topic categories (e.g., the plurality of topic categories includes markets for products in the field of interest, articles in the field of interest, and processes related to the field of interest). Yet further, in such embodiments, three data recordation structures are provided (e.g., each of the three data recordation structures correspond to one of three topic categories including markets for products in the field of interest, articles in the field of interest, and processes related to the field of interest, respectively).

Yet further, in one or more embodiments, portions of the differentiating data description region and the rating region for receiving information associated with one or more subservient descriptions are provided such that information received therein is located in proximity to the subservient description for which the information characterizes (e.g., each of the two or more data recordation structures may be configured as a two dimensional array of cells arranged in columns and rows with the portions of the differentiating data description region and the rating regions provided such that information received therein is located within the same row or column as the subservient description for which the information characterizes).

Still further, in one or more embodiments, the hierarchical structure of the primary data description region for at least one data recordation structure is configured to request dominant and multiple levels of subservient descriptions related to the corresponding topic category. The multiple levels of subservient descriptions include a most subservient description. The generational data description region is configured to request information relating to an increasing level of advancement over time of one or more of the most subservient descriptions in the hierarchical structure.

In one or more embodiments of the system, the two or more data recordation structures may include a market data recordation structure configured to request information regarding industry, market, and client segment descriptions in a primary data description region thereof, the two or more data recordation structures may include an article data recordation structure configured to request one or more family descriptions, one or more genus descriptions for each family, and one or more species descriptions for each family in a primary data description region of the article data recordation structure; and the two or more data recordation structures may include a process data recordation structure configured to request function descriptions indicative of what functions one or more processes are to achieve, operation descriptions indicative of general groups of processes that can carry out such functions, and specific process descriptions indicative of transformation outcomes which fall within the general groups of processes.

In yet another embodiment of the system, the system may include at least one computer apparatus, the two or more data recordation structures may be implemented using multiple worksheets with the summary guide for the field of interest completed using the multiple worksheets (e.g., at least the summary worksheet and one or more of the multiple worksheets being integrated for exchange of information therebetween).

A storage device readable by machine for use in performing a method of analysis of a field of interest is also described which includes two or more data recordation structures. Each of the two or more data recordation structures is configured to receive information and corresponds to one of a plurality of topic categories related to the field of interest. Each of the two or more data recordation structures includes a primary data description region configured to request a hierarchical structure of dominant and subservient descriptions related to the corresponding topic category, a generational data description region configured to request information relating to an increasing level of advancement over time of one or more of the subservient descriptions in the hierarchical structure, a differentiating data description region configured to request information relating to at least one or more differentiating attributes of subservient descriptions provided in the primary data description region and/or relating to at least one or more differentiating attributes of information provided in the generational data description region, and a rating region configured to request ratings for at least one or more characteristics of information in the differentiating data description region.

In one embodiment, the storage device tangibly embodies a program of instructions executable by the machine to provide a summary guide for the field of interest configured to be completed using at least two or more data recordation structures based at least on the ratings provided in the rating region of at least the two or more data recordation structures.

Generally, the above summary of the present invention is not intended to describe each embodiment or every implementation of the present invention. Advantages, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a general flow diagram of one exemplary embodiment of a planning process (e.g., technology platform planning process) implemented using one or more processes and/or tools according to the present invention.

FIG. 2A shows illustrative data recordation structures, and the interrelationship therebetween, which may be used as one exemplary tool in a technology platform planning process, such as that shown as an embodiment of the general planning process in FIG. 1.

FIGS. 2B-2F show illustrative data recordation structures, and the interrelationship therebetween, which may be used as one exemplary tool in various other planning processes, such as shown generally in FIG. 1.

FIG. 3A shows one embodiment of the illustrative data recordation structures of FIG. 2A in more detail.

FIG. 3B shows an exemplary summary guide that may be generated using information from data recordation structures for a field of interest, such as those shown generally in FIGS. 2A and 3A.

FIG. 3C is a flow diagram showing one exemplary interrelationship between, for example, data recordation structures such as shown in FIGS. 2A and 3A and a summary guide such as shown in FIG. 3B, and a technology platform planning process, such as shown as an embodiment of the general planning process in FIG. 1.

FIG. 4 shows a planning tool that may be used in a technology platform planning process, such as that shown as an embodiment of the general planning process in FIG. 1.

FIG. 5 generally shows one or more exemplary systems that may be used to implement one or more analysis tools and/or one or more processes according to the present invention.

FIGS. 6A-6C show an exemplary flow diagram of a field of interest analysis method for use in the implementation of a technology platform planning process, such as shown as an embodiment of the general planning process in FIG. 1, and which uses a plurality of data recordation structures (e.g., worksheets) such as shown in FIGS. 2A and 3A.

FIGS. 7-9 show exemplary flow diagrams for recording information in article, process, and market data recordation structures (e.g., worksheets), respectively, that may be used for implementation of the field of interest analysis method such as shown generally in FIGS. 6A-6C and/or any other field of interest analysis methods or systems.

FIGS. 10-12 show exemplary market, process, and article data recordation structures (e.g., worksheets), respectively, for use as analysis tools according to one or more embodiments of the present invention.

FIG. 13 shows an exemplary summary value guide that may be used in conjunction with one or more data recordation structures (e.g., worksheets), such as those shown in FIGS. 10-12.

FIGS. 14A-14C show exemplary and partially completed data recordation structures (e.g., worksheets) corresponding to those shown in FIGS. 10-12.

### DETAILED DESCRIPTION OF THE EMBODIMENTS

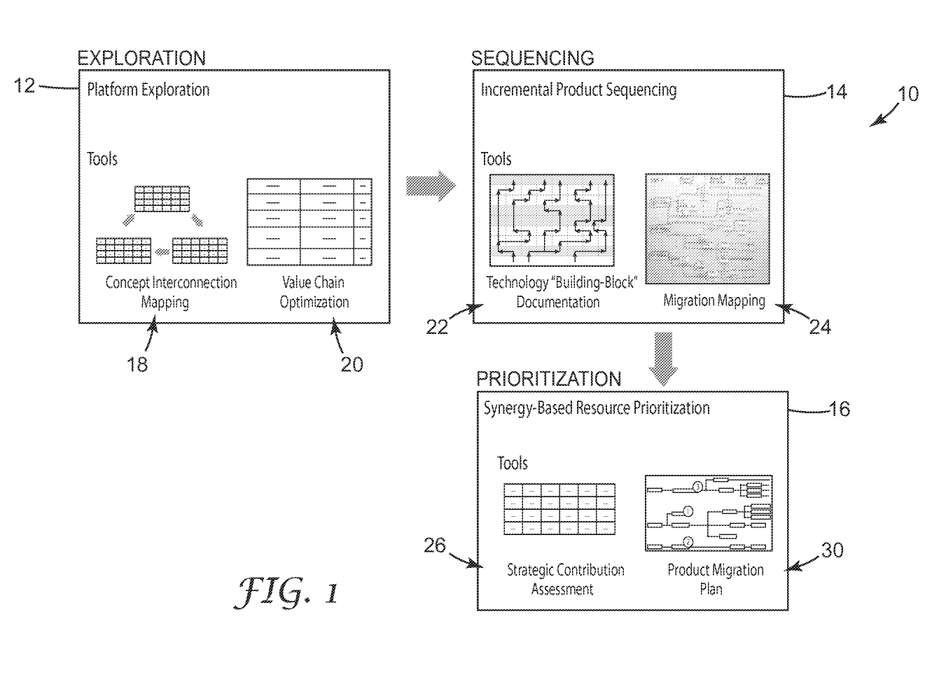

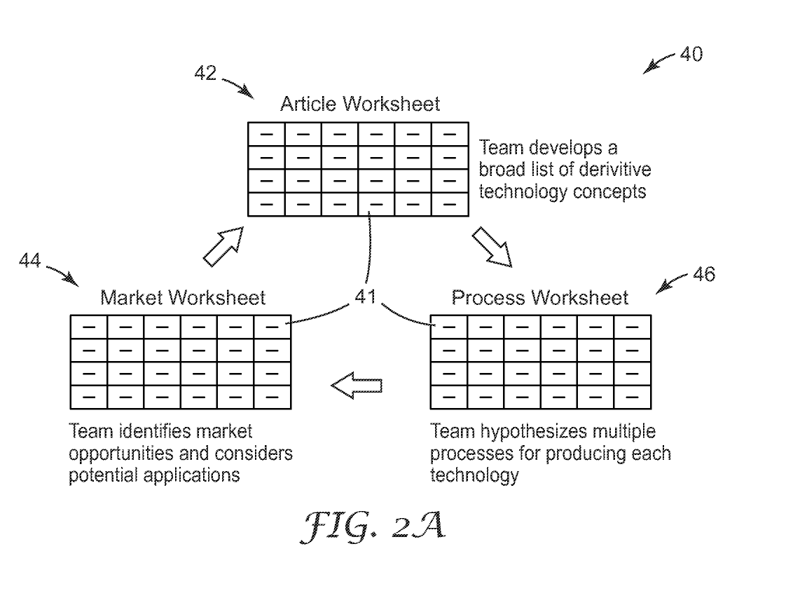

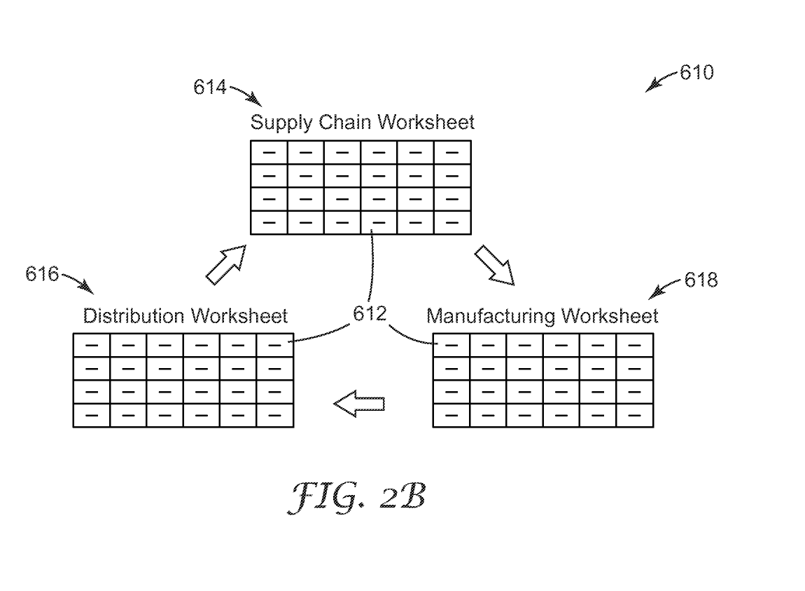

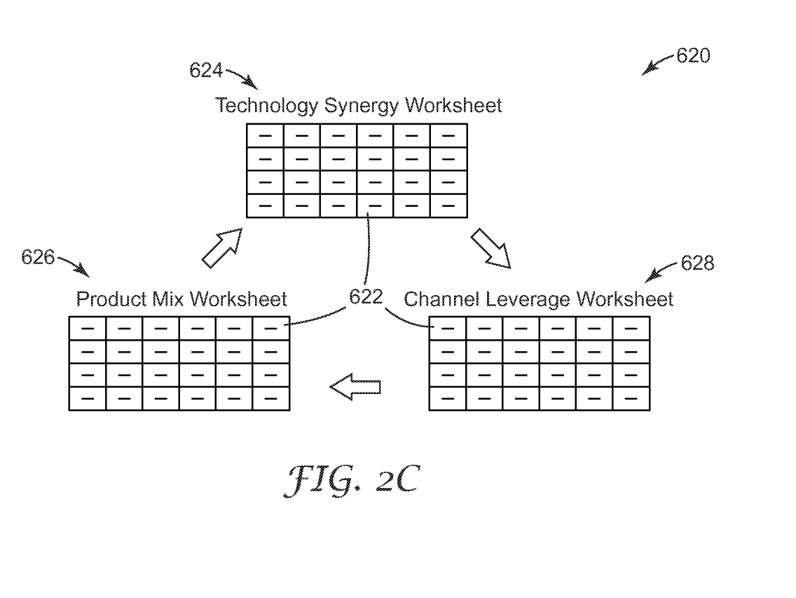

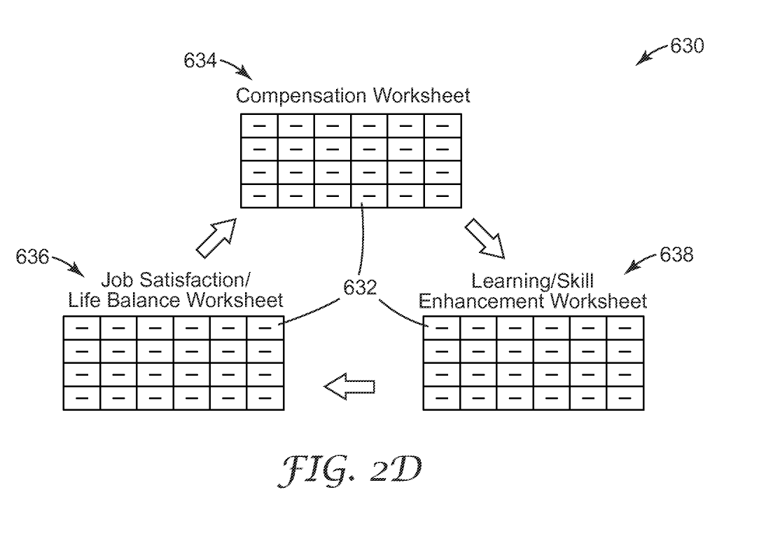

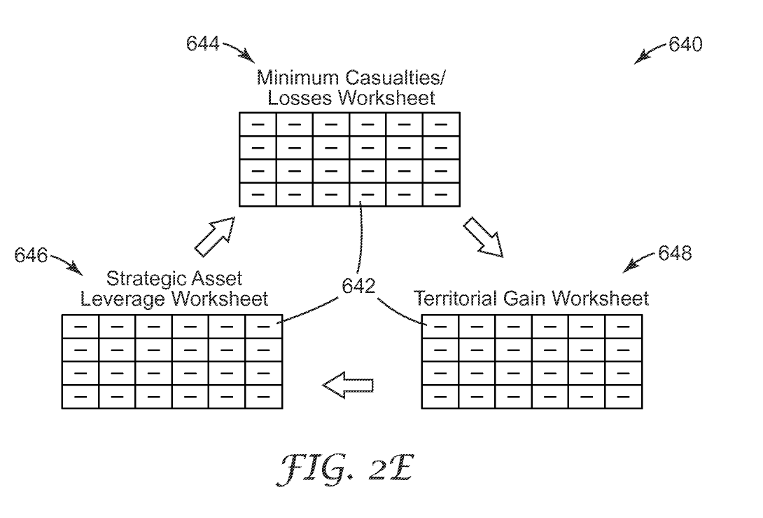

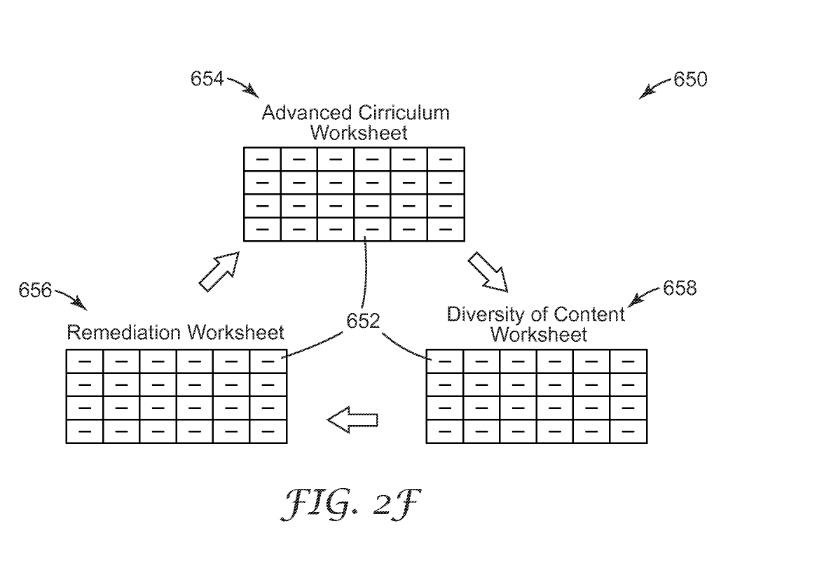

Generally, an exemplary planning process 10 (e.g., an exemplary technology platform planning process) shall be described with reference to FIG. 1. Various illustrative embodiments of such a planning process, as well as various analysis tools, methods, and systems for use in implementing the planning process 10 and/or portions thereof, shall be further described in more detail with reference to FIGS. 2-14.

One skilled in the art will recognize from the description herein that various illustrative embodiments described include some features or elements included in other illustrative embodiments and/or exclude other features or elements. However, analysis of a field of interest according to the present invention may include any combination of features or elements selected from one or more of the various embodiments as described herein with reference to FIGS. 1-14.

For example, one or more portions of the process may be carried out with the assistance of a computer, one or more portions of the process or analysis may be performed with use of software tools that provide worksheets, one or more various portions of the process may be carried out with paper documents in which users record information, etc. Likewise, for example, a planning process 10, such as described in FIG. 1, may be carried out in its entirety or only a portion of the process may be used to analyze a field of interest (e.g., a technology field). One skilled in the art will readily recognize that any number of various embodiments, for example, such as those that use data recordation structures, as described herein, may benefit from one or more of the features described herein.

As used herein, certain terms have the following definition:

“Article” means a distinct thing that is not necessarily connected to a specific need or application. For example, an article may be a product or something that goes into a process. In other words, for example, as used in conjunction with various other terms defined herein, adhesives may be an example of a family, pressure-sensitive adhesives may be a genus within the family, and a species of the genus may be a two-component pressure-sensitive adhesive. In this example, an article that follows therefrom may be a microsphere-filled acrylic. There may be differentiating attributes that can be associated with this article, such as low adhesion build over time, low transfer, and low backscatter. Several products can result from the same or similar articles, or the article could be the product as well. For example, in the above example, a product may be a Post-it® Notes adhesive, or could be a low backscatter diffusing adhesive for computer displays. As such, the definition of articles and products are treated separately according to the present invention.

“Differentiator” refers to a need (e.g., a client need) that is important but is not business critical. For example, a differentiator for a display screen may be that it be shatter-proof.

“Exciter” refers to a need that addresses critical business issues (e.g., the top three issues) for a client. For example, an exciter for a display screen may be that it be light weight. In some cases, a differentiator and an exciter may be the same. However, they can also be different. Exciters and differentiators may be considered for a real-win-worth (RWW) score as described further herein, however, in addition to exciters and differentiators, other considerations may employ whether something is the same, a detractor, and/or non-negotiable.

“Function” refers to a broad description of why something needs to be performed. In other words, it may answer the question: Why does an operation need to be performed?

“Market” refers to a grouping of clients with similar needs that either influence or make purchasing decisions.

“Operation” refers to a general description of a group of processes.

“Process” refers to the transformation of materials or information to something of a higher value.

“Product” refers to a material, device, know-how, transaction, or process marketed (e.g., sold) to a client or in a market.

The illustrative planning process 10, shown in FIG. 1, generally may include multiple processes. For example, as shown in FIG. 1, exploration processes 12 may be used to explore a field of interest, sequencing processes 14 may be used to give some sort of time oriented structure to the results of the exploration processes, and prioritization routines 16 may be used to set priorities for elements related to the field of interest. Although various fields of interest may be considered as part of the planning process 10 (e.g., education planning, military planning, career planning, etc.), one embodiment of a technology platform planning process is further shown in the blocks of FIG. 1.

As shown in FIG. 1, the illustrative embodiment of a technology platform planning process includes applying technology platform exploration tools and/or processes to one or more identified fields of interest (block 12). The one or more identified fields of interest may be identified by an entity (e.g., a technology company) as capabilities available to that entity which differentiate it from competitors and which could be expected to form the basis for future technology platforms. For example, an entity may ask itself questions such as: What do we have that competitors do not have? How else might competitors achieve similar outcomes?

The results of such questioning may identify high value products that an entity has access to that others do not. Such access may be to knowledge (e.g., key personnel), particular markets, or a supply chain. Such access may be to unique knowledge that can be controlled and protected through trade secrets or intellectual property strategies related thereto (e.g., patents, copyrights, etc.). Such identification may come from the definition of projects, a strategic plan, portfolio management, etc.

With a field of interest identified, the technology platform exploration tools may be applied to analyze this field of interest (block 12). As used herein, analysis refers to not only analysis of information already available, but also to the tapping of knowledge from one or more entities or individuals, gathering of new information, or any other manipulation or gathering of knowledge or information. For example, analysis may refer to the use of particular information in a brainstorming manner to generate other information and make judgments relating thereto.

As shown in FIG. 1, technology platform exploration tools 12 may include the use of interconnection mapping tools 18 or summary tools 20, such as a value chain optimization tool as shall be further described herein. For example, interconnection mapping tools 18 may include data recordation structures 40, such as those described herein with reference to FIGS. 2A, 3A, and FIGS. 10-12.

For example, in the application of such interconnection mapping tools 18, an entity may assemble a diverse team of researchers, marketers, intellectual property personnel, and supply chain and manufacturing experts to generate creative combinations of new technologies, processes, and markets related to the field of interest. For example, the team may be guided through a process that helps them to challenge assumptions, identify competitive strengths, and encourage entrepreneurial thinking about potential opportunities. In one exemplary embodiment, the team may iterate between multiple document recordation structures (e.g., worksheets, scratchpads, spreadsheets, etc.) that help to organize ideas and spark creativity by focusing concept exploration around important perspectives that must be brought together for new product concepts to be credible. In one embodiment, such perspectives revolve around markets, processes, and articles.

FIG. 2A shows a plurality of data recordation structures 40 that may be used as an interconnection mapping tool 18 to explore a technology platform relating to a field of interest. For example, such exploration may lead to the identification of derivative technologies, manufacturing processes, potential applications, etc.

The data recordation structures 40, as shown in FIG. 2A, include an article data recordation structure 42, a market data recordation structure 44, and a process data recordation structure 46. Each of the data recordation structures 40 generally includes, at least in one embodiment, a two-dimensional array organized such that a user is able to provide data (e.g., information of any type such as textual, visual, audio, etc.) in one or more various fields. For example, article data recordation structure 42 includes labeled columns (e.g., text providing instructions as to what sort of information is to populate the column) of cells generally represented by reference numeral 41 in each structure which elicit information to be provided in the cells.

For example, in the article data recordation structure 42, a team of individuals may be instructed to develop a broad list of derivative technology concepts related to the field of interest and provide them into cells of one or more fields of the structure 42. Further, for example, the process data recordation structure 46 may be used to elicit information regarding processes for producing one or more of such technology concepts. Yet further, market data recordation structure 44 may be used to elicit identifiable market opportunities and potential applications related to the field of interest from the team.

In one embodiment according to the present invention, the data recordation structures 40 may be used by a team (e.g., research and development personnel, supply chain personnel, marketing personnel, manufacturing personnel, intellectual property personnel, etc.) to facilitate broad and unconstrained thought processes about future possibilities. Such possibilities can be organized into the data recordation structures 40 that highlight interconnections between such data recordation structures 40. The entire team participates actively in idea generation with respect to each data recordation structure 40. For example, such activity may consume 20 to 30 hours, broken up into 2 to 3 hour sessions, over a particular period of time.

Such facilitated information generation using the data recordation structures 40 may be facilitated by a lead individual that can guide discussion, question responses or information provided in the data recordation structures, and/or invite appropriate experts to participate. Such a lead individual may have experience in the field of technology of interest or a strength associated with the supply chain, market position, etc.

As used herein, data recordation structures may take one of various forms. The data recordation structures may be simple tabular word processing worksheets, may be spreadsheets (e.g., Excel spreadsheets), may be worksheets generated by one or more proprietary-type software programs, may be implemented using one or more database applications. For example, in addition to Excel spreadsheets, such worksheets may be implemented using MindMapper™, Lotus Notes™, MindManager™, etc.

The present invention is not limited to any particular implementation of a data recordation structure. However, the data recordation structure is necessary to organize one or more types of information elicited from one or more individuals.

In one or more embodiments, where particular information from one data recordation structure or multiple data recordation structures is used to fill in or otherwise populate another data recordation structure (e.g., worksheet or spreadsheet), the data recordation structure may be stored, or otherwise provided, using a storage device readable by a machine capable of making such transfer of information. For example, as described herein, one or more various types of information (e.g., generational information, rating information, etc.) may be used to populate one or more data recordation structures (e.g., worksheets, scratchpads, etc.), summary guides, etc. In such cases, the data recordation structure will generally be compatible for use with a computer apparatus.

One will recognize that the plurality of data recordation structures may be used as an interconnection mapping tool 18 to explore other fields of interest as well as a technology platform relating to a field of interest. In other words, such tools are useful in implementing a planning process with regard to other fields of interest.

For example, as shown in FIG. 2B, data recordation structures 610 include a supply chain data recordation structure 614, a distribution data recordation structure 616, and a manufacturing data recordation structure 618, for exploring a new business opportunity from an operational point of view. Each of the data recordation structures 610 generally includes, at least in one embodiment, a two-dimensional array organized such that a user is able to provide data in one or more various fields, e.g., in much the same manner as described with reference to the data recordation structures 40 shown in FIG. 2A. For example, supply chain data recordation structure 614 may include labeled columns (e.g., text providing instructions as to what sort of information is to populate the column) of cells generally represented by reference numeral 612 which elicit information to be provided in the cells.

Further, for example, as shown in FIG. 2C, data recordation structures 620 include a technology synergy data recordation structure 624, a product mix data recordation structure 626, and a channel leverage data recordation structure 628, for exploring the possibility of a new business acquisition. Each of the data recordation structures 620 generally includes, at least in one embodiment, a two-dimensional array organized such that a user is able to provide data in one or more various fields, e.g., in much the same manner as described with reference to the data recordation structures 40 shown in FIG. 2A. For example, technology synergy data recordation structure 624 may include labeled columns (e.g., text providing instructions as to what sort of information is to populate the column) of cells generally represented by reference numeral 622 which elicit information to be provided in the cells.

Further, for example, as shown in FIG. 2D, data recordation structures 630 include a compensation data recordation structure 634, a job satisfaction/life balance data recordation structure 636, and a learning/skill enhancement data recordation structure 638, for use in career planning. Each of the data recordation structures 630 generally includes, at least in one embodiment, a two-dimensional array organized such that a user is able to provide data in one or more various fields, e.g., in much the same manner as described with reference to the data recordation structures 40 shown in FIG. 2A. For example, compensation data recordation structure 634 may include labeled columns (e.g., text providing instructions as to what sort of information is to populate the column) of cells generally represented by reference numeral 632 which elicit information to be provided in the cells.

Further, for example, as shown in FIG. 2E, data recordation structures 640 include a minimum casualties/losses data recordation structure 644, a strategic asset leverage data recordation structure 646, and a territorial gain data recordation structure 648, for use in military campaign planning. Each of the data recordation structures 640 generally includes, at least in one embodiment, a two-dimensional array organized such that a user is able to provide data in one or more various fields, e.g., in much the same manner as described with reference to the data recordation structures 40 shown in FIG. 2A. For example, minimum casualties/losses data recordation structure 644 may include labeled columns (e.g., text providing instructions as to what sort of information is to populate the column) of cells generally represented by reference numeral 642 which elicit information to be provided in the cells.

Further, for example, as shown in FIG. 2F, data recordation structures 650 include an advanced curriculum data recordation structure 654, a remediation data recordation structure 656, and a diversity of content data recordation structure 658, for use in education planning. Each of the data recordation structures 650 generally includes, at least in one embodiment, a two-dimensional array organized such that a user is able to provide data in one or more various fields, e.g., in much the same manner as described with reference to the data recordation structures 40 shown in FIG. 2A. For example, advanced curriculum data recordation structure 654 may include labeled columns (e.g., text providing instructions as to what sort of information is to populate the column) of cells generally represented by reference numeral 652 which elicit information to be provided in the cells.

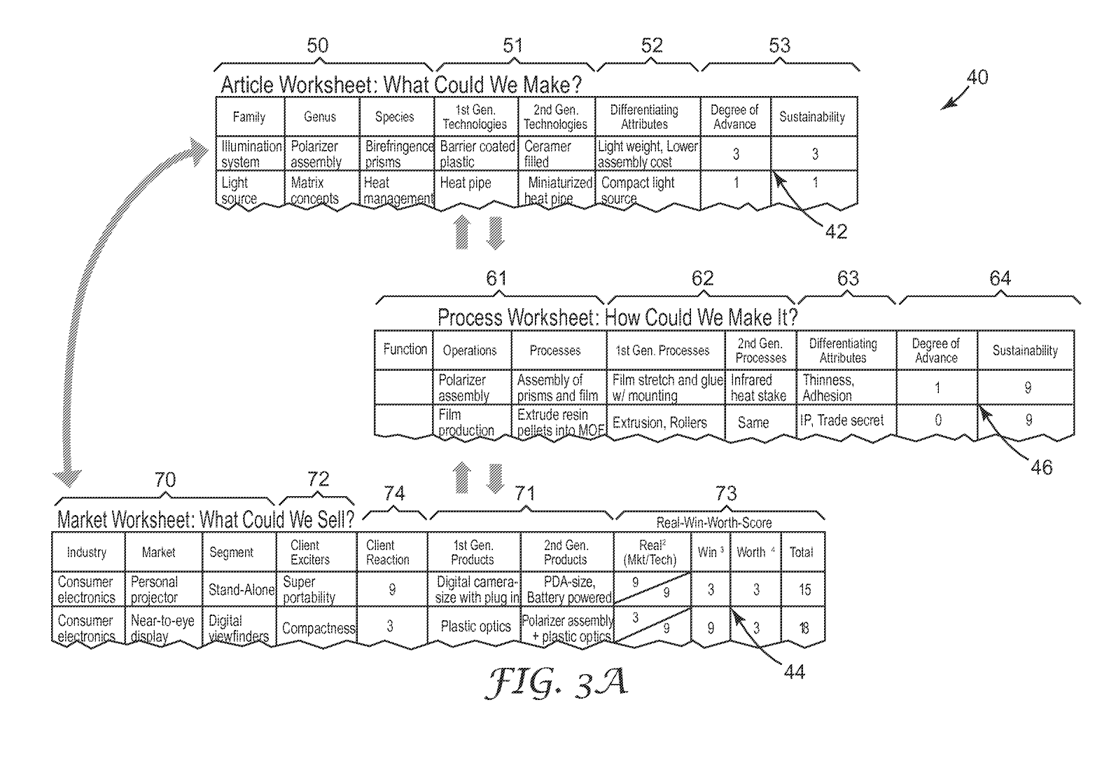

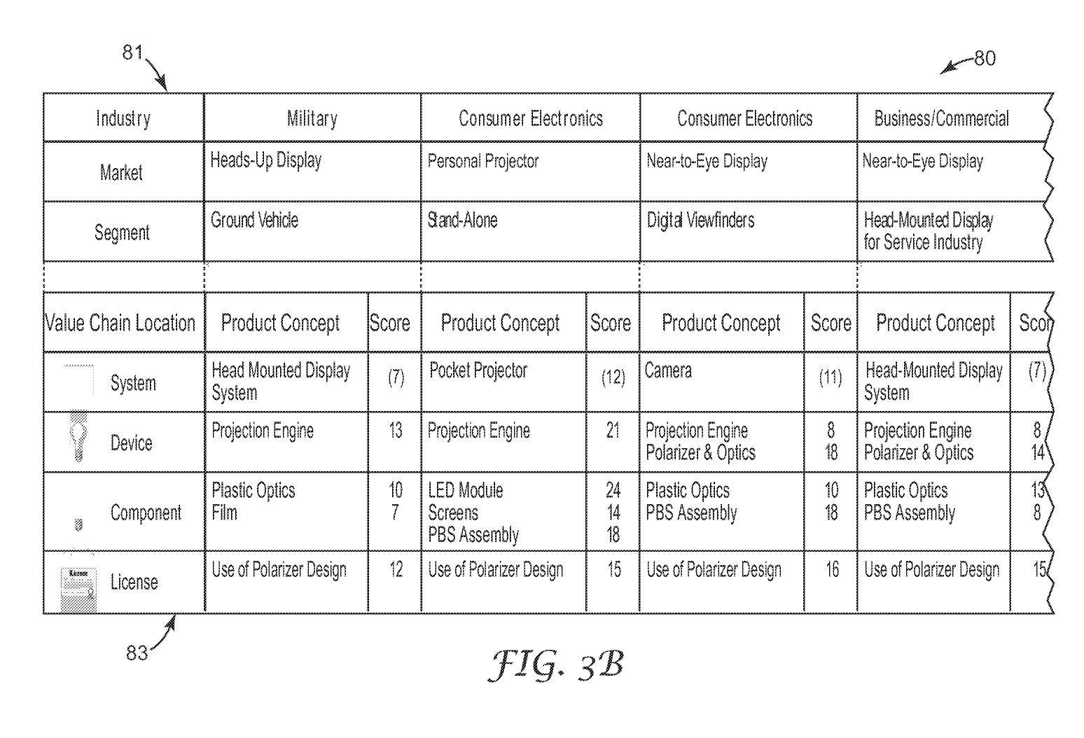

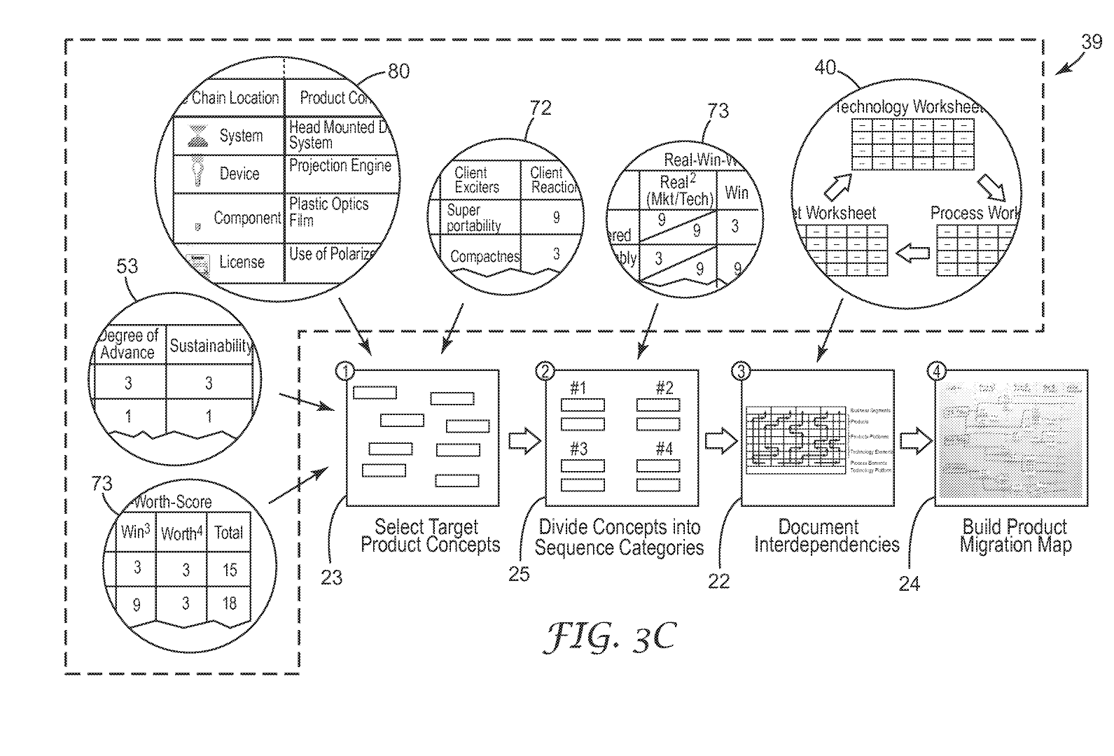

FIG. 3A shows the organizational structure of various exemplary data recordation structures 40. Generally, in one or more embodiments, two or more data recordation structures are provided that correspond to respective topic categories related to the field of interest. The organizational structure of each of the two or more data recordation structures generally includes a primary data description region configured to request a hierarchical structure of dominant and subservient descriptions related to the corresponding topic category. For example, such a configuration may be limited to three columns so as to force concise and effective descriptions in such a tree type hierarchy. A generational data description region is configured to request information relating to an increasing level of advancement over time of one or more of the subservient descriptions in the hierarchical structure.

Further, in one or more embodiments, the organizational structure of each of the two or more data recordation structures includes a differentiating data description region configured to request information relating to at least one or more differentiating attributes of subservient descriptions provided in the primary data description region and/or relating to at least one or more differentiating attributes of information provided in the generational data description region. A rating region of the data recordation structure may be configured to request ratings for at least one or more characteristics of information in the differentiating data description region.

Generally, as shown in the recordation structures described herein, the differentiating data description region and/or the rating region that includes information relating to at least one or more differentiating attributes of subservient descriptions provided in the primary data description region, and/or relating to at least one or more differentiating attributes of information provided in the generational data description region, is located in proximity to the subservient description which the information characterizes. At least in one embodiment, such characterizing information is in the same column or row as the subservient description.

In one embodiment, the data recordation structures 40 for exploring a technology platform, as shown in FIG. 3A, include the article worksheet 42, the process worksheet 46, and the market worksheet 44 corresponding to those shown in FIG. 2A. Each of the data recordation structures 40 is configured to receive information related to at least one of products, articles, or processes in the field of interest. Each of the data recordation structures 40 correspond to one of a plurality of topic categories. As shown in FIG. 3A, the plurality of topic categories include markets for products in the field of interest which corresponds to market data recordation structure 44, articles in the field of interest which corresponds to article data recordation structure 42, and processes related to the field of interest which corresponds to data recordation structure 46. However, one skilled in the art will understand that the plurality of topic categories may change depending on the application incorporating the concepts and methodology described herein.

Further, each of the data recordation structures 40 is configured or arranged in a plurality of regions. In one embodiment, the regions include a plurality of columns labeled to elicit a certain type of information for completion or population of a part of the column or the entire column. However, one will recognize that any arrangement of information which is beneficial to readily understand the information provided in the data recordation structure may be used. For example, labeled rows, separate worksheets for each region, separate worksheets for each row, all three data recordation structures 40 being provided in a same worksheet, etc. are just a few of the various configurations that may provide a beneficial organizational function. In one embodiment, the data recordation structures are provided in a two-dimensional array with a field heading on various columns directing a user to provide information in the data recordation structure 40.

Further, in one embodiment of the data recordation structures, the cells in the fields are kept to a particular character length so as to force individuals to summarize briefly the information to be inserted in the data recordation structure. For example, the cells may be limited to the receipt of less than 50 characters, less than 100 characters, or less than 200 characters. In one embodiment, for example, such field length limitations may be applied to the provision of differentiating characteristics as further described herein.

As shown in FIG. 3A, each data recordation structure 40 includes a primary data description region for receiving a hierarchical structure of dominant and subservient descriptions related to the corresponding topic category, generational data description regions for receiving information relating to an increasing level of advancement over time of one or more of the subservient descriptions in the hierarchical structure, a differentiating data description region for receiving information relating to at least one or more differentiating attributes of subservient descriptions provided in the primary data description region and/or relating to at least one or more differentiating attributes of information provided in the generational data description region, and a rating region for use in rating at least one or more characteristics of information in the differentiating data description region.

Such regions may include one or more subregions. For example, the rating region may include multiple regions at various positions on the data recordation structure for rating one or more various characteristics of the information (e.g., a region for ratings associated with an exciter and a region for ratings associated with other information on the structure).

As shown in FIG. 3A, the exemplary article data recordation structure 42 includes primary data description region 50, generational data description region 51, differentiating data description region 52, and rating region 53. Further, exemplary process data recordation structure 46 includes primary data description region 61, generational data description region 62, differentiating data description region 63, and rating region 64. Likewise, exemplary market data recordation structure 44 includes primary data description region 70, generational data description region 71, differentiating data description region 72, and rating regions 73 and 74.

As will be described further herein, the primary data description region 50 of article data recordation structure 42 is populated with family, genus, and species information. Generational data description region 51 thereof is populated with potential article introduction sequence information (e.g., article introduction over a period of time). Further, differentiating data description region 52 thereof is populated with information concerning how the article is different from what is currently available or from what competitors can do, and the rating region 53 includes rating information with regard to the degree of advancement and sustainability of the technical advancement from the original or conventional technology available.

The primary data description region 61 of the process data recordation structure 46 is populated with information with regard to functions, operations, and processes related to the field of interest. The generational data description region 62 thereof is populated with information of potential process development sequences (e.g., process introduction over a period of time). Differentiating data description region 63 is for receiving information with regard to the differentiating attributes of the processes from conventional processes and/or from competitors' processes, and the rating region 64 is used for rating the degree of advancement and sustainability of such a technical advance from conventional technology and/or that used by competitors.

The primary data description region 70 of market data recordation structure 44 is populated with industry, market, and segment information, and generational data description region 71 is for receiving a potential product introduction sequence across multiple generations of products over time. Differentiating data description region 72 of the market data recordation structure 44 is for information related to client exciters, and rating region 73 and 74 are used to implement a real-win-worth (RWW) scoring methodology and provide a rating for client reaction, respectively.

The various regions of the multiple data recordation structures 40 shall be further described herein with respect to one or more exemplary embodiments. Generally, at least in one embodiment, such data recordation structures 40 allow the evaluation of derivative technologies as the team of individuals is able to consider multiple paths of sustainable technical advance from an original or conventional technology platform using the article data recordation structure 42. The team is able to identify process alternatives by hypothesizing multiple processes for manufacturing each technology using the process data recordation structure 46. Further, the team is able to consider alternative markets and processes generating new product concepts by iterating around the alternatives in the various data recordation structures 42, 44, and 46.

The rating regions of the data recordation structures 40 allow the team to evaluate product concepts by applying ratings to one or more characteristics of information in one or more fields (e.g., the differentiating data description region, the exciter region, etc.) of the various data recordation structures 40 and then comparing them relative to one another. The population of the data recordation structures 40 allows a team to list technologies related to a revolutionary technology platform and look for opportunities to achieve technical advances that can be defended from competitors. Such analysis is a launch point for documenting supply chain and manufacturing capabilities that would enable an entity to produce the technologies. With respect to the market data recordation structure 44, individuals can brainstorm a broad range of product concepts, which often lead back to new processes and article insights. Using the data recordation structures 40, the team can explore ideas with clients to identify the greatest potential, such as with the use of client exciters, and also can score product concepts using a rating methodology (e.g., RWW methodology).

The lay-out and/or organization of the data recordation structures 40 may take one of various forms and may provide for one or more various functions in addition to the recordation of information in fields thereof. As described herein, the length of fields for insertion of various types of information may be limited so as to require an individual populating the field to consider and summarize the information provided or recorded therein. Yet further, one or more of the fields may be required before an individual user is allowed to insert other information in the data recordation structure. For example, the user may be required to provide input in the differentiating data description region and/or rate one or more characteristics of information input therein. Such use of required fields forces a user to fully consider the information inserted into one or more fields of the data recordation structures 40.

In one embodiment, the data recordation structures 40 are in a fixed form. In other words, only a certain number of fields (e.g., columns) are available for use. For example, in one embodiment, a predefined number of columns (e.g., 12) may be used to configure the data recordation structure and labeled for directing a user to complete the data recordation structure. However, further, the data recordation structures may be adjustable for adding one or more fields (e.g., labeled columns for insertion of information). Restriction of the data recordation structures 40 to a particular organizational configuration provides a user with the ability to more easily recognize how to use the data recordation structures 40 and analyze the information therein, particularly when several field of interest are being analyzed using the same tools.

Still further, one or more portions of the data recordation structures 40 may be color-coded. In other words, various portions thereof may be grouped and provided with a color indicating that such color-coded portions have a particular function. In one exemplary configuration, for example, a color may be used to group particular portions of the structure for use in the definition of a strategic plan. In other embodiments, color coding may be used for identifying or prioritizing opportunities, identifying patent priority (e.g., need for protection), identify area where there is a need to reduce an idea to practice, identify ideas enabled by an acquisition, etc.

FIG. 3B shows a summary guide 80 that is generated using data recordation structures 40 for the field of interest based at least on ratings provided in the rating regions of one or more of the data recordation structures 40. For example, the exemplary summary guide 80 provides a way of summarizing and analyzing information from the data recordation structures 40.

The summary guide 80, illustratively shown in FIG. 3B, includes an exemplary market region 81 and an exemplary value chain region 83. The market region 81 includes information drawn from the data recordation structures 40 relating to markets and products that may be suitable for such markets. The value chain region 83 of summary guide 80 draws information from the data recordation structures 40 relating to products or services and ratings associated therewith as they fall within the value chain.

Although value chain may mean different things with respect to the different data recordation structures, as used herein with reference to the market data recordation structures and the summary guide, the highest level of the value chain is content (e.g., information, display content, etc.), followed by systems, devices, components and/or subcomponents, licenses, and, lastly, raw materials. In one embodiment, the process and article data recordation structures use the value chain to indicate progression. Generally, although not necessarily, the flow is from simpler articles to more integrated. For example, the Post-it® Note articles could be represented as follows, where articles toward the top are made from articles lower on the list.

| | | | | Differentiating |
|---|---|---|---|---|
| Family | Genus | Species | Article | Attributes |
| Adhesive | PSA | Two | Microsphere | Low adh, low |
| | | component | filled acrylic | build, low |
| | | | | backscatter |
| Adh solution | Solvent | Full polymer | MS/Acrylic/ | Compatible with |
| | | | MEK | existing processes |
| Microspheres | Polymer | Thermoset | PS/PMMA | Low cost, stiff, |
| | | | copolymer | tunable index |

In one embodiment, the summary guide 80 may be used by an entity to look for opportunities to improve the potential of initial product concepts by considering alternative business models. Further, patterns in the rating regions may present information concerning product sequences to avoid and/or pursue. For example, the use of compound rating methodology, such as the real-win-worth scores, may indicate positions in the value chain that an entity should avoid depending upon the pattern of low scores (see, for example, the 7's shown in summary guide 80 in conjunction with the system location on the value chain for head-mounted displays in FIG. 3B). Yet further, technology applications common to multiple markets, as indicated in summary guide 80, may suggest promising areas for development (see, for example, the term “plastic optics” showing up in multiple markets in FIG. 3B). Such promising technology may lead to an early placement in a product sequence introduction plan (e.g., migration map).

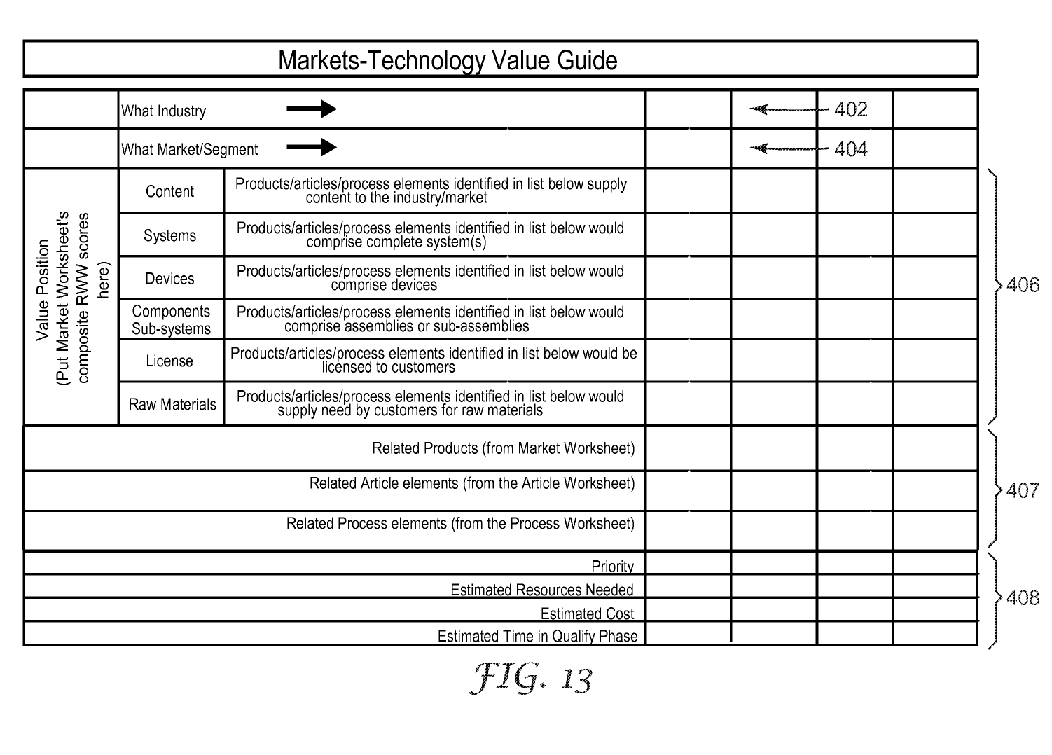

One will recognize that any number of various types of summary guides may be set forth which utilize information provided from the data recordation structures 40. One additional illustrative embodiment of a summary guide is shown and shall be described with reference to FIG. 13.

Such summary guides using data and/or being populated with data from one or more data recordation structures 40 may be implemented in various manners. For example, such information may be generated automatically using certain fields or cells from the data recordation structures 40 to populate the summary guide 80. In such a manner, the generation of the summary guide is part of a computer-assisted process. However, manual generation of such a summary guide may also be used as well. Yet further, one of the data recordation structures may actually function as a summary guide. For example, the market data recordation structure with RWW scores may operate as a summary guide.

In general, the summary guide is the location where related articles, processes, products and markets are collected into proposed business opportunities. Different business models can be proposed through the value chain and scored. Such a guide may provide for the logical business launch sequence. For example, it could be based on technology readiness, market need, or the strategic intent of platform execution.

With further reference to FIG. 1, using the platform exploration tools 12, such as interconnection mapping tools 18 (e.g., data recordation structures 40), and/or summary tools 20 (e.g., summary guide 80), an organization or entity may further analyze the field of interest through an incremental product sequencing process 14, as shown in FIG. 1. Yet further, thereafter, a synergy-based resource prioritization process 16 may also be performed. However, the platform exploration tools 12 may be used for any particular purpose and in combination with any subsequent processing and/or analysis techniques. For example, such technology platform exploration tools 12 may be used for strategic planning, product sequencing, migration mapping, resource allocation, etc. In other words, the results provided using the technology platform exploration tools 12, including the interconnection mapping tools 18 and the summary tools 20, may be used alone or may be analyzed further and/or processed further by an organization for one or more beneficial purposes.

One exemplary embodiment of subsequent processing and/or analysis of information available upon application of the technology platform exploration tools 12 (e.g., using a field of interest analysis method) is shown in FIG. 3C. FIG. 3C provides a block diagram showing a subsequent incremental product sequencing process 14 using one or more types of information available from the application of platform exploration tools 12.

Generally, the illustrative incremental product sequencing process 14 includes identifying promising product concepts (block 23) and organizing such promising product concepts into sequence categories based on, for example, their readiness for development (block 25). For example, in identifying the most promising product concepts, value chain location information from a summary guide 80 may be used to identify the most promising location in the value chain; a client exciter section 72 may be used to review client responses that validate market attractiveness; advance and sustainability scores in the rating region 53 may indicate high potential technologies; and real-win-worth scores from a rating region 73 may also highlight product concepts having promising value. In other words, various types of information from the application of the technology platform exploration tools 12 may be used for identification of promising product concepts (block 23).

Further, for example, the division of concepts into sequence categories (block 25) may also be performed using information resulting from the application of platform exploration tools 12. For example, the rating region 73 of the market data recordation structure 44 (e.g., real scores) may highlight early development opportunities and thus allow an entity to divide the concepts into sequence categories (block 25).

Further, as shown in FIG. 3C, interdependencies and/or relationships between the articles, processes, and markets associated with the product concepts can be documented (block 22) as the data recordation structures 40 (e.g., market, article, and process recordation structures) contain implicit interdependency assumptions. By waiting until later in the technology platform planning process 10 to document interdependencies (block 22), one can avoid overly narrow selection of specific technology applications. Using such organized product concepts (block 25) and documented interdependencies (block 22), an entity may combine sequence information and interdependency to provide a product migration map (block 24). Such a map plans for a series of incremental product launches over a particular period of time.

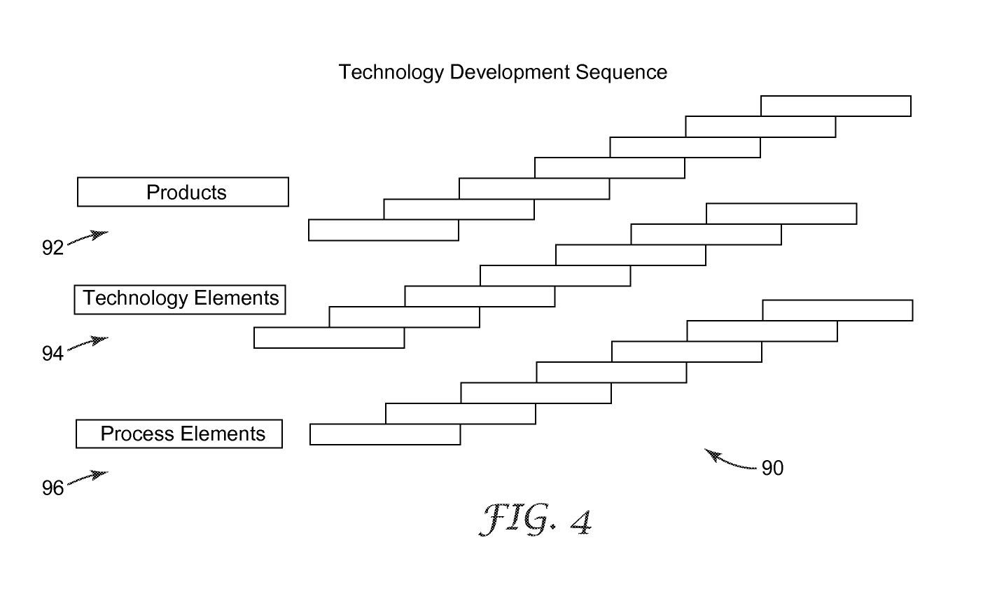

FIG. 4 shows an exemplary diagram of processing in an exemplary technology platform planning process 10, such as shown in FIG. 1, that uses the results of the platform exploration tools 12 described herein. For example, FIG. 4 shows a technology development sequence 90 over time for product concepts, as shown by sequence 92; technology elements or articles, as shown by sequence 94; and process elements, as shown by sequence 96.

However, one will recognize that other vehicles such as a technology platform product matrix may also be used, for example, to illustrate the relationship in a technology platform. For example, the relationship between various process technology elements, technology article elements, product forms or platforms, products and business segments may be illustrated in a matrix form for use by an entity in strategic planning or for any other purpose.

With still further reference to FIG. 1, the synergy-based resource prioritization process 16, may utilize various tools for determining where to place near-term product investments within a platform. For example, a strategic contribution assessment tool 26 may be used to determine the strategic contribution of potential early product launches (e.g., that may pave the way for other products on a migration map). For example, each near-term product option may receive an overall strategic contribution score based on the degree to which it is expected to create knowledge that will benefit the development of future products. Such strategic assessment may involve the use of a financial score and direct investment resources toward products having highest total scores. Using such strategic contribution assessment tools 26 may lead to the generation of a product migration plan for the development and introduction of products into the marketplace, as shown generally by reference numeral 30.

In view of the description herein, one will readily recognize that various types of analysis or processing of information following the application of the platform exploration tools may be used. As such, the present invention is not limited to only the types of subsequent processing or analysis described herein.

As described herein, one or more portions of the technology platform planning process 10, as shown in FIG. 1, including the generation of data recordation structures 40 and/or summary guides 80, or, in other words, the use of interconnection mapping tools 18 and/or summary tools 20, may be implemented using a paper document system and/or may be implemented with computer assistance. As used herein, computer assistance means that a computer or processing apparatus, along with appropriately functional software, may be used to perform one or more functions described herein. For example, a computer-assisted system may provide a word processing tool or a spreadsheet tool for performing one or more functions according to the present invention, may provide for allowing a user to record information in one or more data recordation structures according to the present invention, and/or may provide for automatically populating one or more data recordation structures or summary guides according to the present invention.

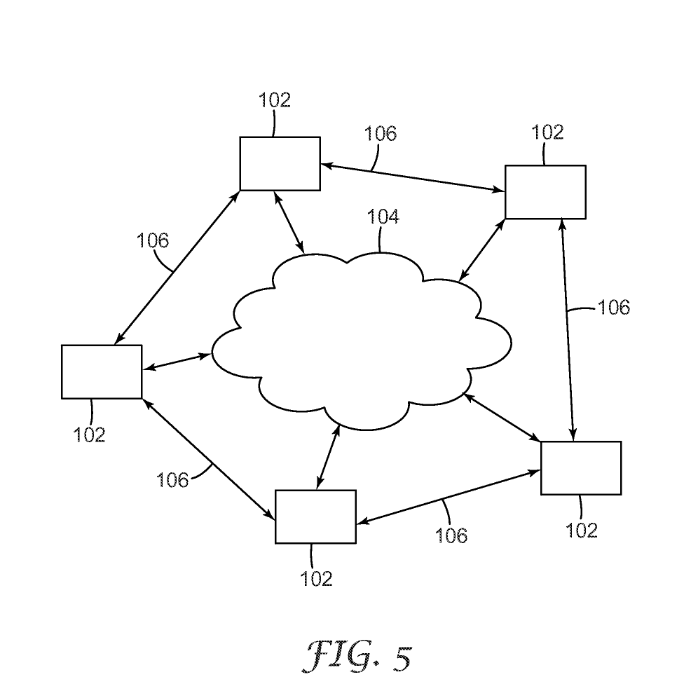

FIG. 5 generally shows one or more illustrative and exemplary embodiments of a technology platform development system 100 that may be used to implement one or more portions of the technology platform planning process 10 such as shown generally in FIG. 1 according to the present invention. The technology development system 100, as shown in FIG. 5, may include one or more processing apparatus 102 (e.g., computer workstation, laptop, personal computer, etc.). For example, one or more portions of the process may be implemented using software installed or embodied on a computer system 102, generally shown in FIG. 5. The computer system 102 can be any standard computer system that is well-known in the art which may include one or more of the following parts: a processing unit, computer memory, an input/output device controller, a keyboard, a pointing device (e.g., a mechanical computer mouse, a mouse that uses a trackball, an optical mouse, a touchpad, or any other similar pointing device), a monitor or some other similar display device, a hard disk drive or some other similar memory storage device, and/or a printer.

The system 100 may be associated with a computer network server, indicated generally by lines 106, or any other suitable network, internet, and/or intranet configuration, such as shown by blob 104, so that one or more portions of the present invention can be shared by multiple users simultaneously, may be used individually, and/or transferred from one entity or individual to another. The methods and/or configurations of the computer hardware and/or software, which can be used for storing and transferring data and for inputting the data into the system, may be numerous. For example, the data can be manually entered or imported from databases or from other electronic spreadsheet applications. Various tools can be used for recording data, accessing other electronic spreadsheets residing on servers or on other devices that are in communication with the present system, etc.

The system 100 is suitably installed such that one or more software applications can be launched and run by one or more users, when desired. For example, a computer operating system, such as available from Microsoft Corporation (e.g., Windows® product line) and spreadsheets, such as Microsoft's Excel® product line, may be utilized to implement one or more portions of the present invention, including the data recordation structures 40 such as shown and described herein. The system 100 is not limited to any specific configuration of devices, operating systems, or electronic spreadsheet software applications. Yet further, such data recordation structures may be implemented without computer assistance.

As such, those skilled in the art will recognize that one or more various techniques may be used with and/or complemented or supplemented by a variety of computer systems, hardware components, and/or software applications including, but not limited to, Visual Basic® for macro-generation, etc. Further, one will recognize that one or more worksheets of a spreadsheet may be utilized for the population of other sheets within a same file or to populate sheets of any other files. The configuration of the technology platform development system 100 is provided by way of illustration and not by way of limitation. As such, one will recognize that any manner of carrying out one or more functions performed by the present invention is contemplated herein.

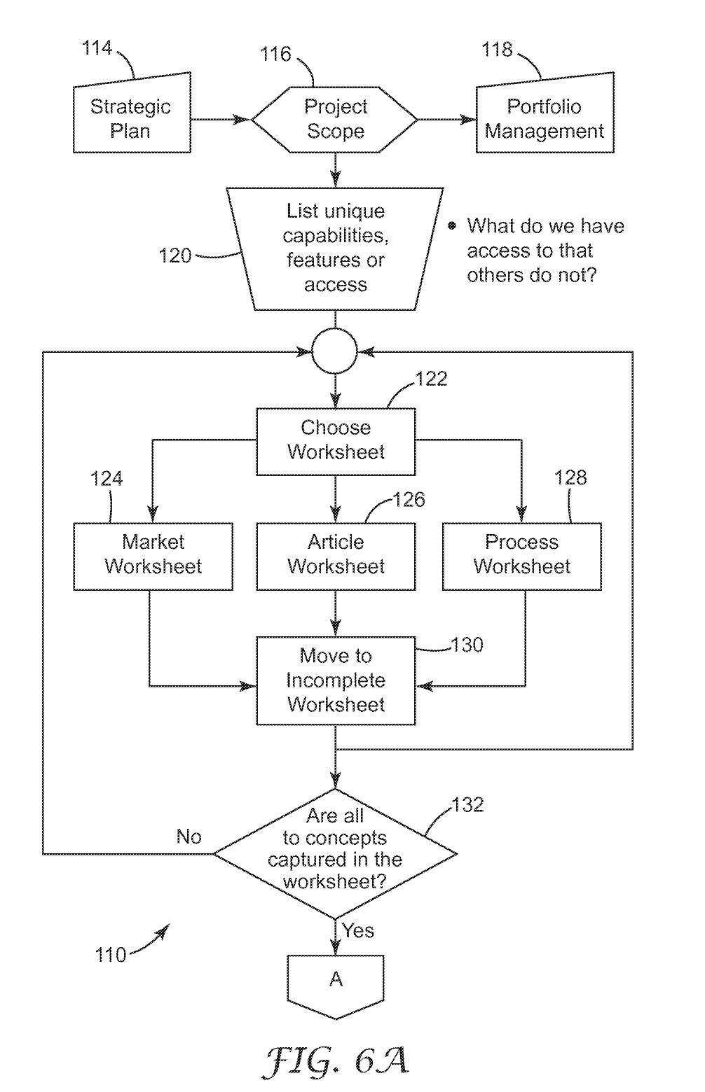

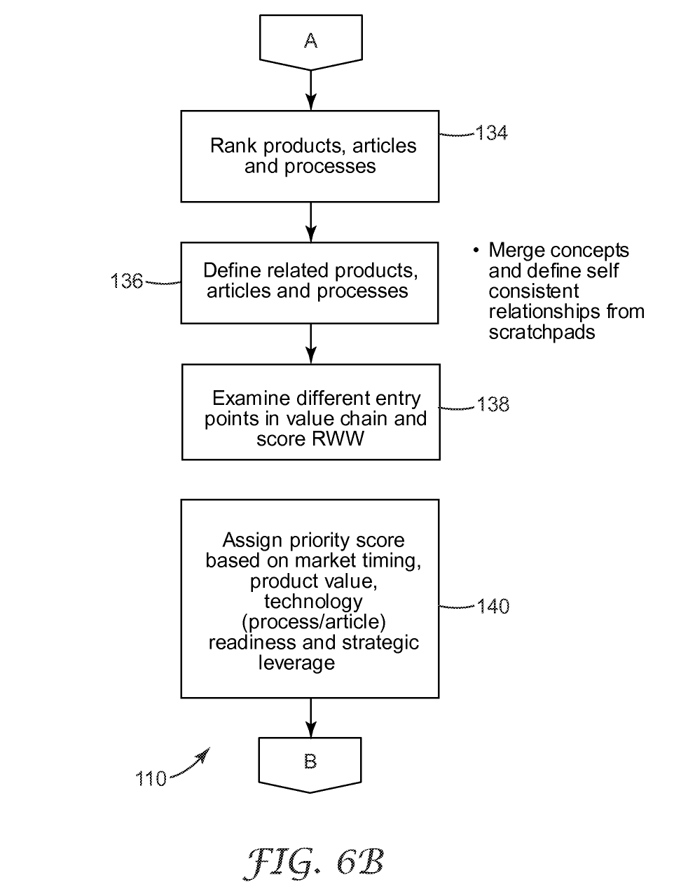

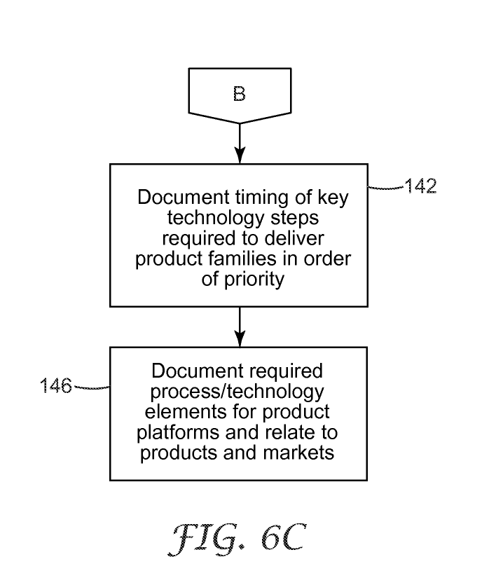

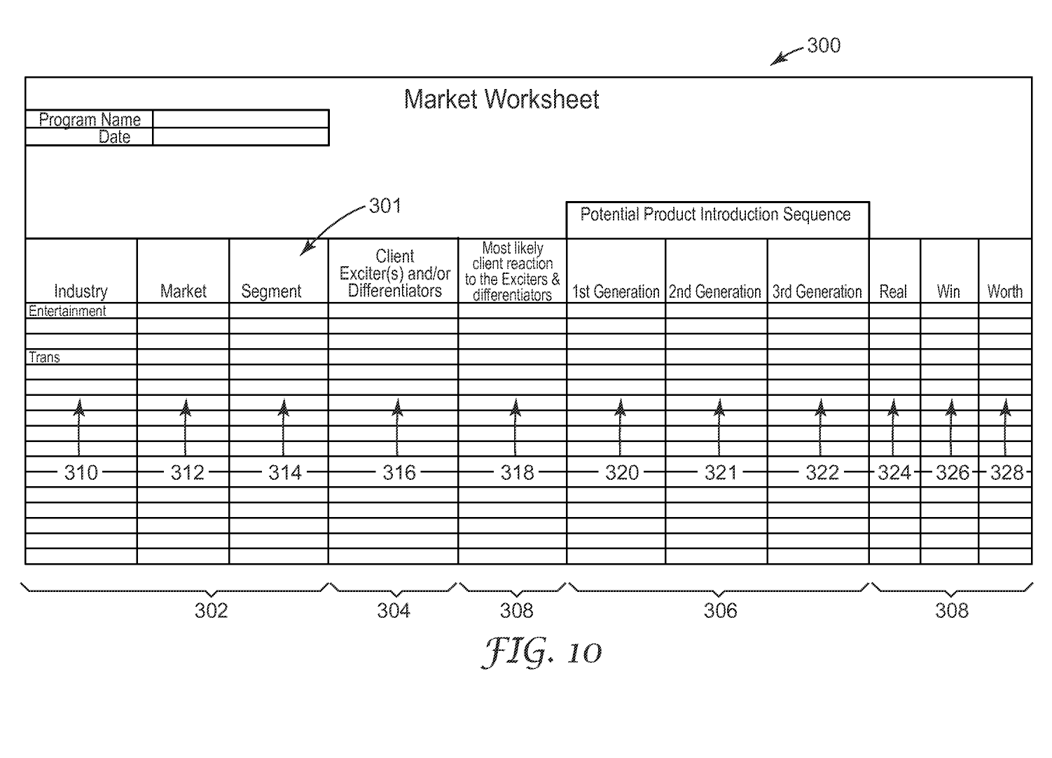

One embodiment of a field of interest analysis method 110 that may be used in a technology platform planning process 10, such as shown in FIG. 1, and which employs the use of data recordation structures according to the present invention, is shown in the flow diagrams of FIGS. 6-9. An exemplary set of data recordation structures in the form of worksheets 300, 330, and 360 are shown in FIGS. 10-12, respectively, and a summary value guide 400 is further shown in FIG. 13. The exemplary field of interest analysis method 110 shall be described in reference to such data recordation structures and summary guide as shown in FIGS. 10-13 in conjunction with the flow diagrams shown in FIGS. 6-9.

Generally, at least in one embodiment, the process provides a framework from which a non-incremental new business can be built. The process is capable of synthesizing a number of new product options from an initial position and provide the framework for managing and sustaining the competitive advantage of the resulting portfolio. For example, use of the process may result in a family of related, compelling outcomes (e.g., in the form of product concepts) which are generated by building upon and iterating around an initial seed idea. It is noted that although various examples are given for starting the process from technology concepts, (e.g., field of interest), such a field of interest is not necessarily limited to the use of a seed technology concept, but families of product concepts may result from use of any seed idea. For example, such seed ideas may include, but are not limited to, a brand (e.g., Post-it®), a process, a product form or channel position, or any other seed idea that can be used in the analysis process to build a compelling new business platform.

Furthermore, at least in one or more embodiments, the process may provide benefit in managing the resulting family of opportunities in a number of ways. For example, the process requires documentation of some of the most basic assumptions associated with the technology of interest, process, market attributes, and product value that support the suggested opportunity. Such assumptions are therefore made explicit and the verification data associated with these assumptions can be requested and monitored through various stage-gate™ processes. Further, the process documents basic points of differentiation in technology processes or features that can be used to build strategy for sustaining the value proposition around the business.

In addition, the process allows for strategizing on alternate methods to generate product offerings, thereby allowing business teams to proactively respond to competitive response. Unique ideas are also captured in the process that may form the basic template for an intellectual property strategy for the business. Still further, the process builds a portfolio of possibilities that are all related by common elements that are repeatedly leveraged through the process. This yields a new business platform that can be managed by focusing on relatively few items that can be validated through product launches and product development but have dramatic leverage on the overall portfolio value.

Generally, the field of interest analysis method 110 may be facilitated in one of various manners. For example, in one embodiment, the worksheets 300, 330, and 360, as shown in FIGS. 10-12, respectively, may be worked on by one or more various teams, for example, with multiple individuals having access for the input of data to the worksheet(s) or with a designated individual having access to complete the worksheet(s). For example, small teams (e.g., six or less people) may work together on one worksheet at a time. Further, for example, two or three teams can be formed, each with a facilitator, to work on different worksheets and, potentially, the teams can be brought together at the end of the meeting to review results. Thereafter, additional meetings may start with all members and start with reviewing the results and considering information (e.g., ratings) provided in the worksheets. At all times, individuals and/or teams may continue adding new ideas and reiterate completion or population of the worksheets.

In another embodiment, large and/or small teams may use a brainstorming session or process to generate ideas. Once complete, a small group may take the results of the brainstorming session and organize them through use of worksheets 300, 330, and 360. Such brainstorming ideas may cover a broad range of concepts.

Yet further, a network process may be used to facilitate the method with one to three individuals and, thereafter, the worksheets 300, 330, and 360 may be sent to other individuals and/or teams to add concepts and ideas in reiteration for population of the worksheets.

One will recognize that the population of the document recordation structures, including the market worksheet 300, the process worksheet 330, and the article worksheet 360, may be facilitated in one or more various manners and the present invention is not limited to any particular process. However, such worksheets 300, 330, and 360 provide a novel tool for the organization of ideas and provide significant and advanced information for subsequent analysis. As indicated above, the worksheets can be used either individually, for example, by those skilled in one field, or as a group across functional fields (e.g., marketing, manufacturing, engineering, etc.) by individuals and/or teams.

In one embodiment, as shown in FIG. 6A, the analysis method 110 may be initiated by defining the scope of a project (block 116). For example, the scope of the project may be based on a management goal, a discovery of a new technology, an acquisition, and/or underutilized capital equipment. Generally, larger scope projects result in an increase in time needed to complete the worksheets described herein. For example, project scope may be defined as a novel low tack adhesive, uniform sized glass microspheres, or use of a brand name (e.g., a trademark). In defining the scope of the project, one may involve the use of an already-created strategic plan (block 114) and/or a management portfolio (block 118) that provides significant technology information (e.g., patented technologies, trade secret technologies, trademark, etc.).

Upon project scope definition (block 116), in order to define the field of interest to be analyzed, an entity may consider listing names of technologies, products, supply chains, and markets that apply to the project scope and where the entity is either competitive in a business sense or a leader (block 120). The list may elevate relevant areas to a higher level where the entity performing the analysis has a particular strength or where access to market, supply chain, etc. is available so as to gain a broad perspective of information relevant to the project scope. For example, in one embodiment, the list may include what an entity knows or has unique access to in the field of interest that others do not. Thereafter, the data recordation structures in the form of the market worksheet 300, process worksheet 330, and article worksheet 360 are provided for use as a tool in performing the field of interest analysis method 110.

As shown in block 122, one of the market worksheet 300, process worksheet 330, and article worksheet 360 is chosen. Which worksheet is selected first generally is not significant, as the iterative process used to complete the worksheets 300, 330, and 360 will result in the population of all required fields.

In one embodiment, the individual and/or individuals may begin with a worksheet that seems most relevant, particularly to the scope of the project. For example, teams of engineers and scientists may begin with the process worksheet 330 or the article worksheet 360, as they are generally more familiar with the technology field from the manufacturing point of view as opposed to products and markets. On the other hand, marketing personnel may be more familiar with products and markets, including segments thereof, and therefore may feel more comfortable working with the market worksheet 300 first. One will recognize that often teams will start mixing concepts, processes, articles, and products for particular markets and that the other worksheets may be used as storage mechanisms for ideas that do not fit on the initial worksheet selected.

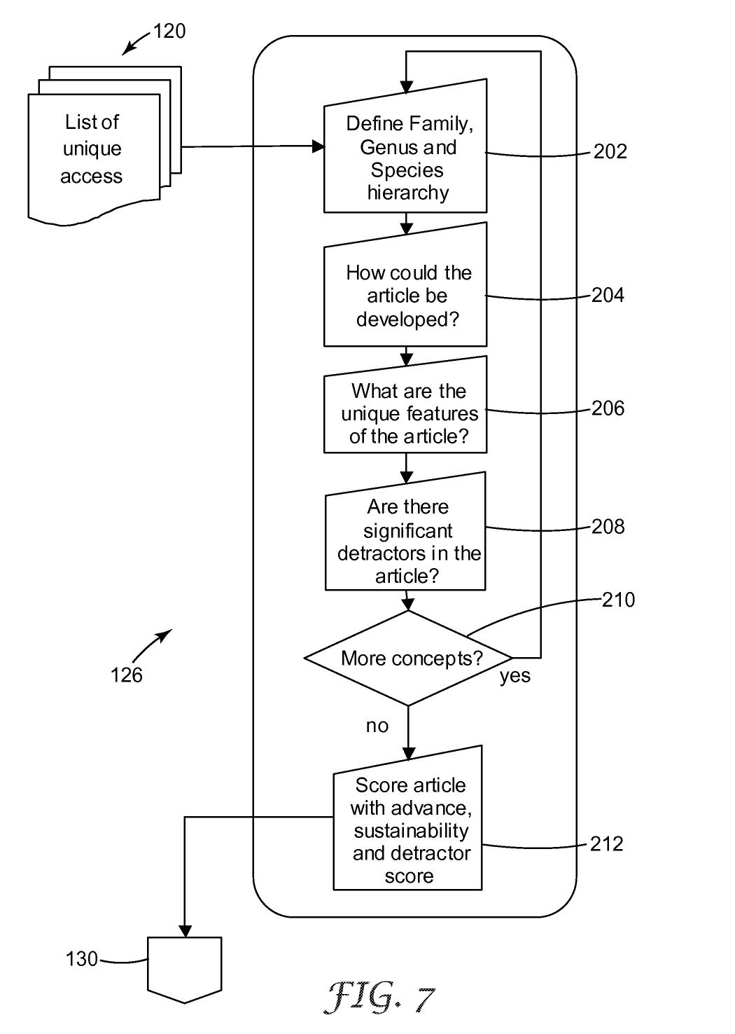

For purposes of initiating an exemplary completion of worksheets 300, 330, and 360, the article worksheet 360 is selected for completion (block 126). One embodiment of an illustration for completing the article worksheet 360 is shown in FIG. 7.

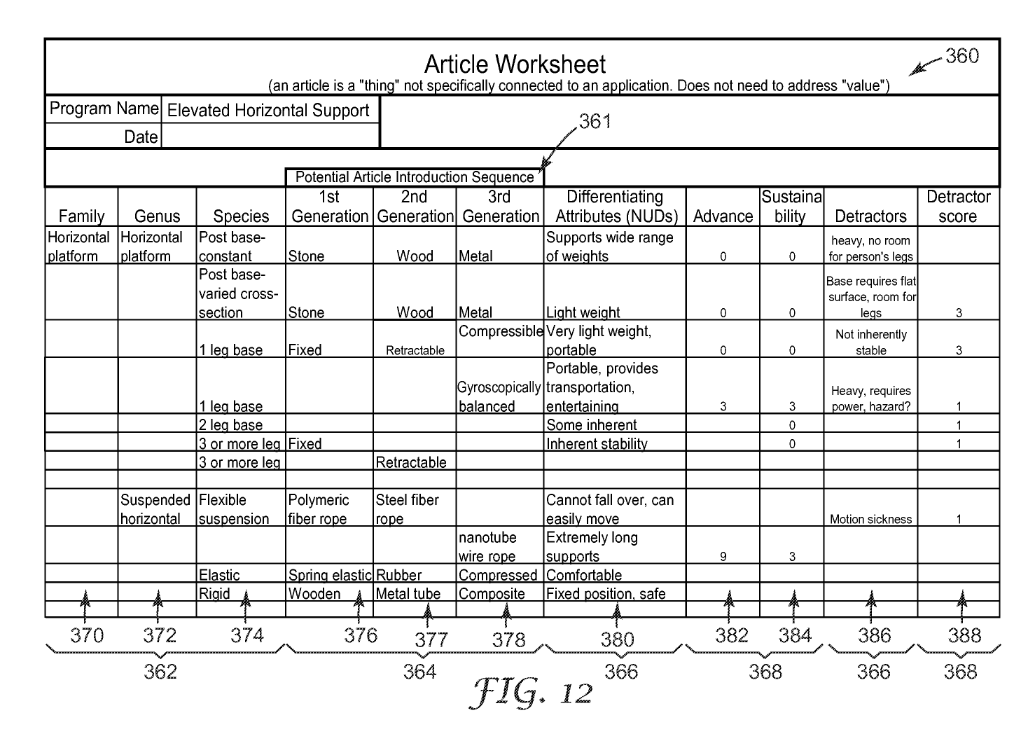

The exemplary article worksheet 360, as shown in FIG. 12, includes primary data description region 362, generational data description region 364, differentiating data description region 366 (e.g., columns 380 and 386), and rating region 368 (e.g., columns 382, 384, and 388). The article worksheet 360 is laid out in a two-dimensional array including columns defining fields for entry of data, as well as such columns being labeled with a header 361 to elicit data from users.

The primary data description region 362 provides a hierarchical configuration for receiving dominant and subservient descriptions related to the topic category of articles in the field of interest. In other words, a tree structure of dominant and subservient descriptions is provided in the primary data description region 362. In the exemplary embodiment shown in FIG. 12, the organizational hierarchy for the primary data description region 362 includes columns including headers for family 370, genus 372, and species 374.

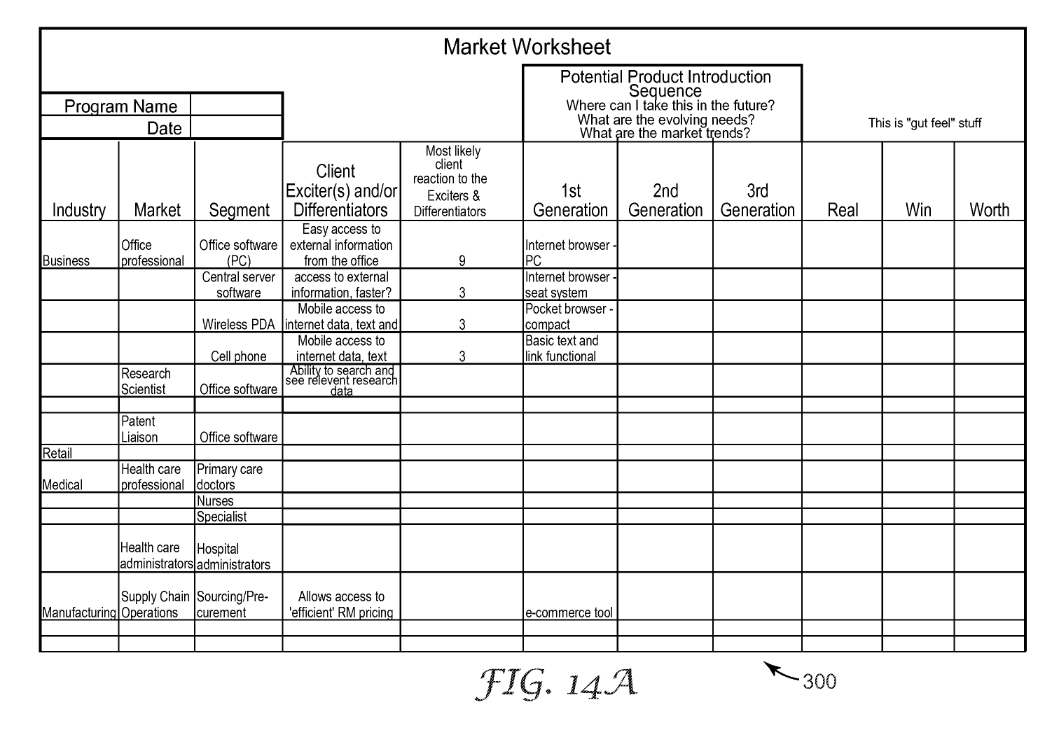

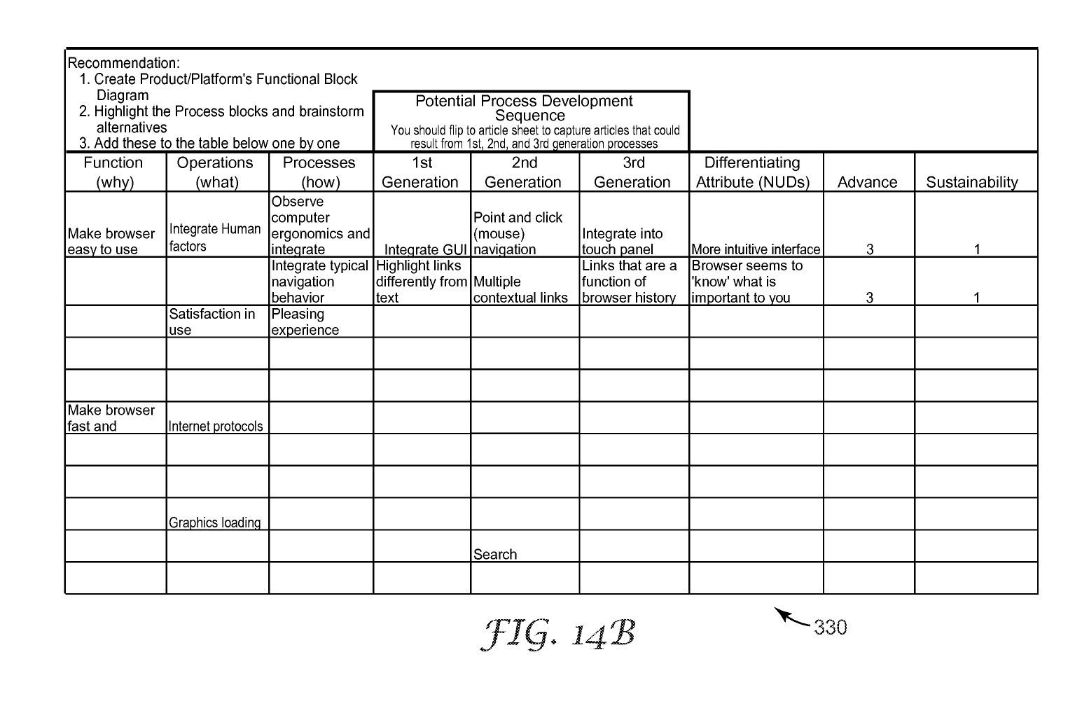

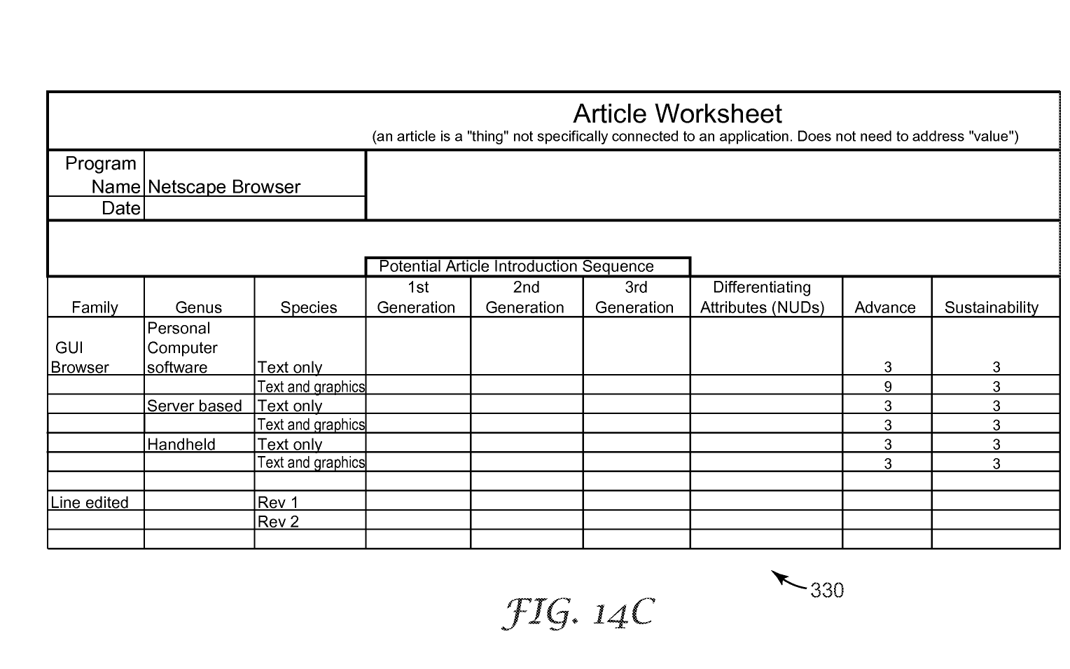

The family column 370 is for listing a foremost core technical grouping. The genus column 372 is for receiving information concerning related subgroupings to a family provided in the family column 370, and the species column 374 is for receiving information of related subgroupings to the genus. Exemplary data is provided in FIG. 12 relating to family, genus, and species information for an elevated horizontal support (e.g., family is horizontal platform, a genus of the family is a suspended horizontal platform, and a species of the genus is a flexible suspension). Further, exemplary data for this region can be found in an exemplary article worksheet found in FIG. 14C relating to family, genus, and species information for browser technology (e.g., family is GUI browser, a genus of the family is personal computer software, and a species of the genus is text and graphics).

The primary data description region 362 of the article worksheet 360, as well as the primary description regions of the other worksheets, provide a series of columns that are to be respectively completed with very broad information, followed by a narrower set of information, and thereafter, provided with a very focused set of information in the final column. In this manner, ideas are organized so as to provide a most subservient description in the final column of the primary data description region, which, in many cases, provides for a basis for population of a substantial portion of other worksheet columns.

For example, in article worksheet 360, species column 374 is the most subservient column, and many of the items provided in regions 364, 366, and 368 relate to the information provided in the most subservient species column 374. However, one will recognize that such information may also relate to other subservient columns (e.g., not necessarily the most subservient). For example, this may be the case when the species description is the same as that of a less subservient column, or when additional more subservient information is unavailable.

The generational description region 364 of article worksheet 360 includes first, second, and third generation potential article columns 376-378, respectively. By providing generations of articles in columns 376-378 along with the development of generational sequences for products and processes in market worksheet 300 and process worksheet 330, one can capture advances in technology, manufacturing capability, and market trends and needs. Generations that are extensions of a prior generation can be on the same row, if the second or third generation created a substantial advance, or it may be appropriate to add additional rows.

The potential article introduction sequence provided in region 364 may take into consideration answers to questions such as: Where can I take this in the future?; What are the evolving needs?; and What are the market trends? This is true not only for the completion of the potential article introduction sequence region 364, but is also applicable to the generational data description regions of the market worksheet 300 and process worksheet 330.

The differentiating data description region 366 of article worksheet 360, shown in FIG. 12, includes a differentiating attributes column 380 and detractors column 386. Each of these differentiating columns include associated rating region columns 382, 384 and 388, respectively. Differentiating attributes column 380 is populated with information about how the article is different from what is currently available or from what the competition can do. Differentiating attributes listed in column 380 are then rated as to their advance and sustainability in columns 382 and 384. For example, the rating in the advance column 382 captures the degree to which a new article gives new capability, or, in other words, the significance of the advance. In one embodiment, for example, a significant advance may be given a value 9, a substantial advance may be given a value 3, some degree of advance may be given a value 1, and a 0 may be used for no advance at all.

In addition, the sustainability column 384 is used to rate how long the advance can be retained either through likely intellectual property protection, know-how, or other limitations on access to the advance in technology by others. Again, for example, if strong and long sustainability is possible then the rating may be a value 9; a good sustainability may be given a value 3; a probable sustainability may be given a value 1; and 0 may be given if no sustainability is anticipated.

As opposed to positive differentiating attributes, as provided in column 380, detractor differentiating attributes are provided in detractors column 386. In other words, features of the article (e.g., in the most subservient primary description region column) that would detract from the utility of the article are listed in column 386. Thereafter, a detractor score rating is provided in column 388 for corresponding detractors of column 386. For example, the ratings indicate how severe the detractors are and whether they can be overcome. In one embodiment, for example, a significant and long detractor is given a value 9; a substantial and medium detractor is given a value 3; a some or short detractor is given a value 1; and a 0 is used is it really is no detractor at all.

In general, and as shown in the exemplary flow diagram of FIG. 7, the article worksheet 360 is completed by defining family, genus, and species hierarchy (block 202) by completing primary description region 362. The question, “How could the article be developed?” (block 204) is then asked so as to provide a potential article introduction sequence into generational data description region 364. Unique features of articles are provided in the differentiating attribute column 380 (block 206) and detractors of such articles are provided in detractor column 386 (block 208). This process is reiterated, as provided by decision block 210, for multiple hierarchical descriptions. Thereafter, the rating regions 368 including advance scores, sustainability scores, and detractor scores (block 212) are completed. In other words, one or more of the differentiating attributes (e.g., either positive or negative) are subjectively rated with regard to the sustainability or significance of the attributes over time relative to currently available articles that may be presented by others in the future and/or the degree of differentiation of the differentiating attributes.

With further reference to FIG. 6A, upon completion of one or more portions of the article worksheet 360, the participants in the analysis method 110 may move to incomplete worksheets (block 130). In other words, with a partial or entire population of one of the worksheets 300, 330, or 360, one may move to one of the other worksheets for completion of the whole or a portion thereof.

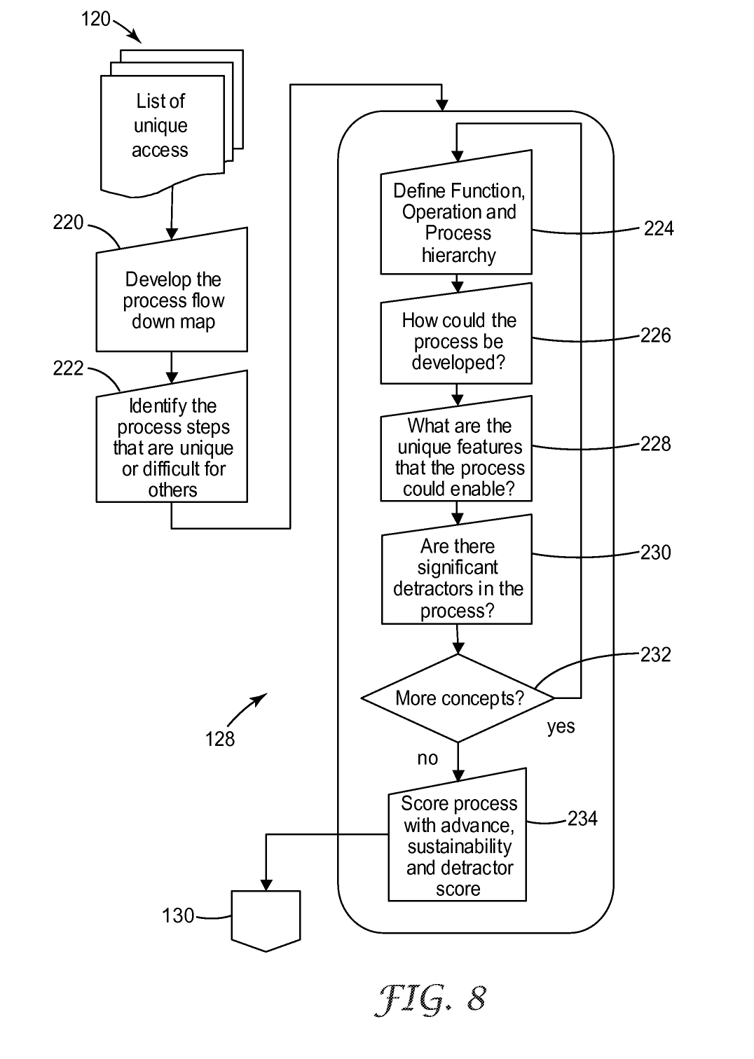

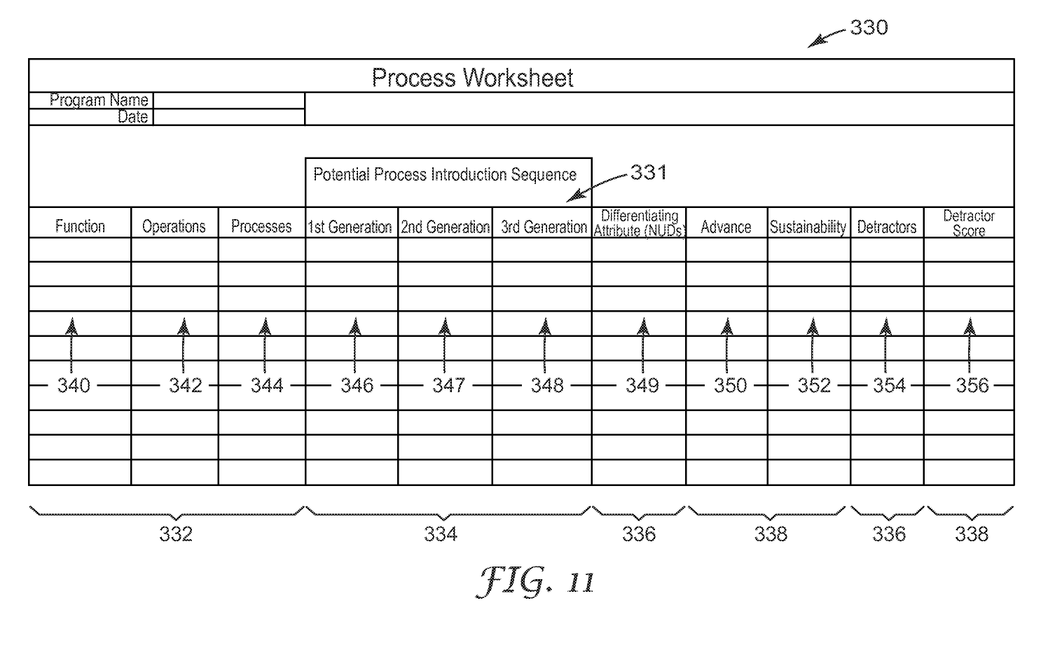

One embodiment of an illustration for completing the process worksheet 330 is shown in FIG. 8. The exemplary process worksheet 330, as shown in FIG. 11, includes primary data description region 332, generational data description region 334, differentiating data description region 336 (e.g., columns 349 and 354), and rating region 338 (e.g., columns 350, 352, and 356). The process worksheet 330 is laid out in a two-dimensional array including columns defining fields for entry of data, as well as such columns being labeled with headers 331 to elicit data from users.

The primary data description region 332 provides a hierarchical configuration for receiving dominant and subservient descriptions related to the topic category of processes in the field of interest. In other words, a tree structure of dominant and subservient descriptions is provided in the primary data description region 332. In the exemplary embodiment shown in FIG. 11, the organizational hierarchy for the primary data description region 332 includes columns including headers for function 340, operations 342, and processes 344.

The function column 340 is for listing reasons of why an operation needs to be performed or, in other words, a broad description of why something needs to be done. The operations column 342 is for receiving information concerning a general description of a group of processes (e.g., related processes) that may fulfill the need of the function column 340, and the processes column 344 is for receiving information regarding to the transformation of materials or information to something of higher value. Exemplary data for this region can be found in an exemplary process worksheet found in FIG. 14B relating to operation, function, and process information for a browser technology (e.g., a function is making the browser easy to use, an operation of the function is satisfaction of use, and a process related to the operation is to make use a pleasing experience).

The primary data description region 332 of the process worksheet 330 provides a series of columns that are to be respectively completed with very broad information, followed by a narrower set of information, and thereafter, provided with a very focused set of information in the final column. In this manner, ideas are organized so as to provide a most subservient description in the final column of the primary data description region (e.g., process column 344), which, in many cases, provides for a basis for population of a substantial portion of other worksheet columns. For example, in process worksheet 330, processes column 344 is the most subservient column, and many of the items provided in regions 334, 336, and 338 relate to the information provided in the most subservient processes column 374. However, one will recognize that such information may also relate to other subservient columns (e.g., not necessarily the most subservient). For example, this may be the case when the processes description is the same as that of a less subservient column, or when additional more subservient information is unavailable.

The generational description region 334 of process worksheet 330 includes first, second, and third generation potential process columns 346-348, respectively. By providing generations of process in columns 346-348 one can capture advances in technology, particularly, for example, manufacturing capability. The potential process introduction sequence provided in region 334 may take into consideration answers to questions such as: Where can I take this in the future? and What are the evolving needs?

The differentiating data description region 336 of process worksheet 330, shown in FIG. 11, includes a differentiating attributes column 349 and detractors column 354. Each of these differentiating columns includes associated rating region columns 350, 352, and 356. Differentiating attributes column 349 is populated with information about how the process article is different from what is currently available or from what the competition can do. Differentiating attributes listed in column 349 are then rated as to their advance and sustainability in columns 350 and 352. For example, the rating in the advance column 350 captures the degree to which a new process gives new capability, or, in other words, the significance of the advance. In one embodiment, for example, a significant advance may be given a value 9, a substantial advance may be given a value 3, some degree of advance may be given a value 1, and a 0 may be used for no advance at all.

In addition, the sustainability column 352 is used to rate how long the advance can be retained either through likely intellectual property protection, know-how, or other limitations on access to the advance in technology by others. Again, for example, if strong and long sustainability is possible then the rating may be a value 9; a good sustainability may be given a value 3; a probable sustainability may be given a value 1; and 0 may be given if no sustainability is anticipated.

As opposed to positive differentiating attributes for the processes, as provided in column 349, detractor differentiating attributes are provided in detractors column 354. In other words, features of the process (e.g., the process in the most subservient primary description region column) that would detract from the IS utility of the process are listed in column 354. Thereafter, a detractor score rating is provided in column 356 for corresponding detractors of column 354. For example, the ratings indicate how severe the detractors are and whether they can be overcome. In one embodiment, for example, a significant and long detractor is given a value 9; a substantial and medium detractor is given a value 3; a some or short detractor is given a value 1; and a 0 is used is it really is no detractor at all.

In general, and as shown in the exemplary flow diagram of FIG. 8, the process worksheet 330 is completed by defining function, operation, and process hierarchy (block 224) by completing primary description region 362. This is performed after, for example, review of the list of unique access points (block 120), development of a process flow down map (e.g., a non-proprietary process map) (block 220), and/or identification of process steps that may be unique to the entity doing the analysis or difficult for others to perform (block 222).

Then, for example, the question, “How could the process be developed?” (block 226) may be asked so as to provide a potential process introduction sequence into generational data description region 334. Unique features of processes are provided in the differentiating attribute column 349 (block 228) and detractors of such processes are provided in detractor column 354 (block 230). This process is reiterated, as provided by decision block 232, for multiple hierarchical descriptions.

Thereafter, the rating region 336 including advance scores, sustainability scores, and detractor scores (block 234) are completed. In other words, one or more of the differentiating attributes (e.g., either positive or negative) are subjectively rated with regard to the sustainability or significance of the attributes over time relative to currently available processes that may be presented by others in the future and/or the degree of differentiation of the differentiating attributes.

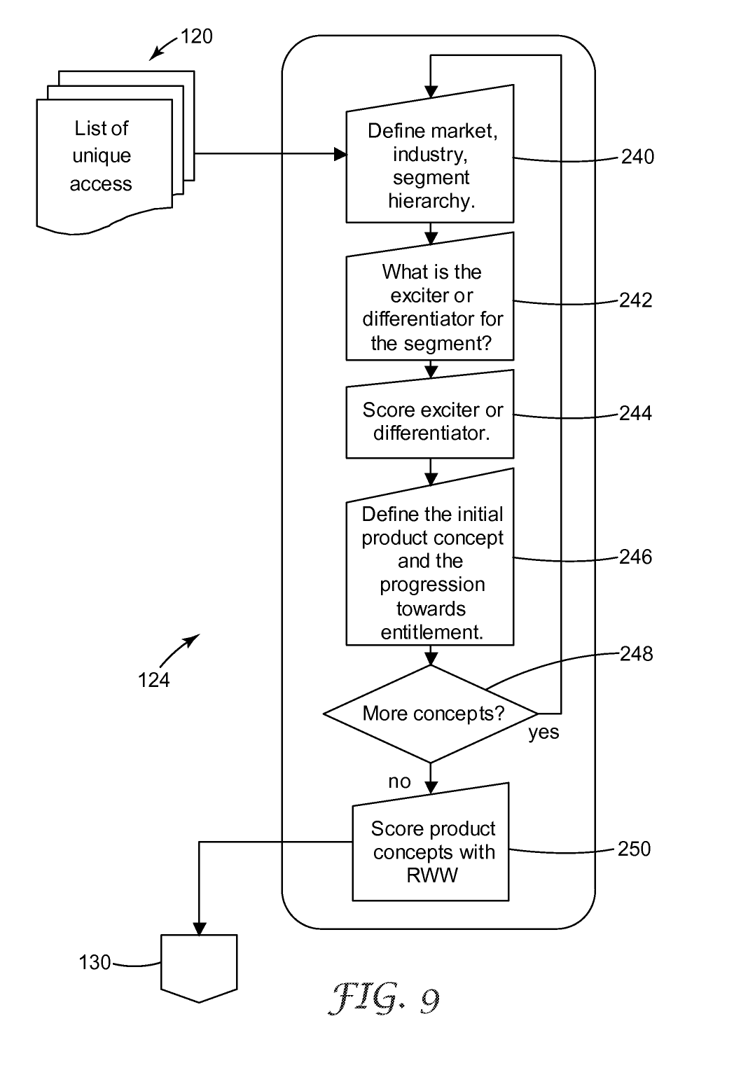

One embodiment of an illustration for completing the market worksheet 300 is shown in FIG. 9. An exemplary market worksheet is shown in FIG. 1O. The exemplary market worksheet 300, as shown in FIG. 10, includes primary data description region 302, generational data description region 306, differentiating data description region 304, and rating region 308 (e.g., columns 318, 324, 326, and 328). The market worksheet 300 is laid out in a two-dimensional array including columns defining fields for entry of data, as well as such columns being labeled with headers 301 to elicit data from users.

The primary data description region 302 provides a hierarchical configuration for receiving dominant and subservient descriptions related to the topic category of markets for the field of interest. In other words, a tree structure of dominant and subservient descriptions is provided in the primary data description region 302. In the exemplary embodiment shown in FIG. 10, the organizational hierarchy for the primary data description region 302 includes columns including headers for industry 310, market 312, and segment 314.

The industry column 310 is for listing one or more different industries such as, for example, healthcare, transportation, electronics, construction, agriculture, and military or defense. The market column 312 is for receiving information concerning subcategories for an industry provided in the industry column 370 (e.g., healthcare markets may include medical, surgical, pharmaceutical, dental, home health care, etc.) The segment column 314 is for receiving information of relating to a grouping of clients with similar needs who either influence or make purchasing decisions. For example, these may be the entity or persons who would send you a check (e.g., original equipment manufacturers). Exemplary data for this region can be found in an exemplary market worksheet found in FIG. 14A relating to industry, market and segment information for a browser technology (e.g., an industry may be business, a market of the business industry may be an office professional, and a segment in the market may be central server software).

The primary data description region 302 of the market worksheet 300 provides a series of columns that are to be respectively completed with very broad information, followed by a narrower set of information, and thereafter, provided with a very focused set of information in the final column. In this manner, ideas are organized so as to provide a most subservient description in the final column of the primary data description region (e.g., market segment column 314), which, in many cases, provides for a basis for population of a substantial portion of other worksheet columns.

For example, in market worksheet 300, market segment column 314 is the most subservient column, and many of the items provided in regions 304, 306, and 308 relate to the information provided in the most subservient column 314. However, one will recognize that such information may also relate to other subservient columns (e.g., not necessarily the most subservient). For example, this may be the case when the species description is the same as that of a less subservient column, or when additional more subservient information is unavailable.

The generational description region 306 of market worksheet 300 includes first, second, and third generation potential product columns 320-322, respectively. By providing generations of products in columns 320-322 one can capture advances in technology and market trends and needs. The potential article introduction sequence provided in region 304 may take into consideration answers to questions such as: Where can I take this in the future?; What are the evolving needs?; and What are the market trends?

The differentiating data description region 304 is configured to receive information about client exciters and/or differentiators in column 316. For example, such exciters or differentiators may include things that address critical business issues for a client or where the client can say, “Wow, there's nothing quite like it.” Such client differentiators and exciters are rated in column 318 of region 308 by a likely client reaction. For example, a strongly favorable and delighted reaction may receive a value 9; a positive, let's talk reaction may receive a value 3; an o.k. reaction may receive a value 1; and a 0 may be given to no reaction or a negative reaction.

Additional ratings provided on the market worksheet 300 in rating region 308 relate to a real-win-worth (RWW) score. Three columns (e.g., real column 324, win column 326, and worth column 328) are utilized to rate the potential product introduction sequence provided in generational data description region 306 of market worksheet 300.

In the real column 324, a rating is provided concerning whether it can actually be done. For example, if it clearly can be accomplished, then a 9 value may be given; if it probably can be accomplished, then a 3 value may be given; if it is possible but unclear whether it can be accomplished, then a 1 value may be given; and if it is not possible, a 0 may be used.

In the win column 326, it is questioned whether the entity can actually do it and whether the entity using the analysis method has access to the manufacturing/supply chain necessary to do it. For example, if there is no problem in the entity performing the necessary steps to product introduction, then a 9 value may be given; if it is only probable, then a 3 value may be given; if it is possible, but less than probable, then a 1 value may be given; and if it cannot be done, then a 0 may be used.

With respect to the worth column 328, the participant(s) rating the product, do so with respect to whether it is actually worth the time and effort. For example, if it is definitely worth the time and effort, then a value 9 may be given; if only probably worth the effort, then a 3 value may be given; if only possibly worth the effort, then a 1 value may be given; and if it is definitely not worth the time and effort, then a 0 may be used.

It will be recognized that the real-win-worth scores or ratings are provided by a gut feel, tribal knowledge, and/or team judgment, and are subjective ratings. The real-win-worth scores are kept very simple for simple and fast evaluation. This eliminates a complex task of designing criteria for weighting non-incremental opportunities.

In general, and as shown in the exemplary flow diagram of FIG. 9, the market worksheet 300 is completed by defining industry, market, and segment hierarchy (block 240) by completing primary description region 302. The question, “What is the exciter or differentiator for the segment?” (block 242) is then asked so as to provide unique features of products in the client exciter or differentiator column 316 (block 242). Thereafter, the exciter or differentiator in the column 316 is scored (block 244).

The process may continue with the definition of an initial product concept so as to provide a potential product introduction sequence in generational data description region 306 such that the progression is towards entitlement (e.g., the best possible manifestation of the product concept). This process is reiterated, as provided by decision block 248, for multiple hierarchical descriptions. Thereafter, the columns for RWW scores are completed for the products (block 250).

One will recognize that the various worksheets may be worked on (e.g., populated with information) in one or more different manners. For example, various sections thereof may be completed while moving to other sections of other worksheets and then going back to previously completed worksheets or to worksheets that were incomplete.

In one embodiment, generally, the primary data description region of one of the worksheets is completed, organizing the ideas in an organization hierarchy, and thereafter doing the same with respect to the primary data description regions of each of the other worksheets. Thereafter, segment exciters and differentiators on the market worksheet 300 may be identified. For example, the market segments are groups of clients with similar needs and businesses. This group of client opinions on one or more exciters and differentiators should be captured.

Following the identification of segments, exciters, and differentiators on the market worksheet 300, the generational data description region of the worksheets may be filled. There may be additions to or the organization of the primary data description regions may be changed, as necessary. For example, generations of products, articles, and processes capture advances in technology, manufacturing capability, and market trends and needs. As generations are completed, participants may also be developing new concepts for the other two worksheets and move from one sheet to another as needed to capture the ideas.

Yet further, thereafter or therebefore, differentiation, advance, and sustainability for the process and article worksheets may be completed. Differentiation is a brief summary statement on how the product, article, or process is different than what is currently available. Also, typically later in the worksheet completion process, real-win-worth scores are completed. Any number of scoring techniques may be used for any one or more of the rating regions.

With further reference to the flow diagrams of FIGS. 6A-6C, once all the concepts are captured in the worksheets (block 132), then one or more various techniques may be used to further utilize the information elicited and provided using the worksheets. For example, as described herein, a summary guide may be used to provide or integrate data from the market, article, and process worksheets, such as described with reference to FIGS. 10-12. Such a summary guide may identify potential best industry/market opportunities, may prioritize participation activity, and may communicate certain information to management for decision-making processes.

One exemplary summary or value guide 400 is provided and shall be described with reference to FIG. 13. The value guide 400 includes industry and market description regions 402, 404, a product/article/process rating region 407, and a prioritization region 408.

The exemplary product/article/process rating region 407 extracts information from the market, article, and process worksheets 300, 330, and 360 and lists therein items from the first, second, and third generational description regions to which participants in the process gave the highest RWW scores. Such information may be automatically extracted and provided to populate the region 407 of the value guide 400, or may be manually provided through no computer assistance.

Generally, in conjunction with population of region 407, the industry and market that gave rise to such products, articles, or processes are provided in industry region 402 and market region 404, respectively. Such information is provided for various industries and market segments across multiple columns of the summary guide 400.

The value position region 406 is completed using the RWW scores for the technology concept in the value position box that best fits its position on the value ladder. As shown therein, the value chain includes content that is supplied to the industry/market, systems which are elements identified that would comprise complete systems, devices which are elements identified that would comprise devices, components or subsystems which are elements identified that would comprise assemblies or subassemblies, licenses which are elements identified that may be licensed to particular clients, and/or raw materials which are identified as those that supply a need shown by clients for raw materials. When completing region 406, product family opportunities may be brainstormed up and down the value chain ladder in anticipation that one or more positions in the value chain may have a higher value score in a new position.

Yet further, the priority region 408 may be completed with information concerning what the priority of the column (e.g., identified by industry and market segment) should be, what resources would be needed to undertake the opportunity, what is an estimated cost to undertake the project, and what is the estimated time to develop the project. For example, in creation or population of the value guide 400, the market worksheet may be reviewed by RWW score to sort the entries. Participants in the analysis process may review and discuss the industries, markets, and products that were highest rated and begin to integrate the results on the value guide 400 with entries from the article and process worksheets. The most promising product families may be brought into the value guide 400. The columns are filled, as described above, and, at least in one embodiment, the columns are analyzed for combinations that would facilitate similar or parallel development activities.

The summary guide 400 may be used as part of the product, article, and process ranking, as shown in FIG. 6B (block 134). Further, subsequent processing of information using data recordation structures (e.g., market worksheets) may be performed, as further shown and described with reference to FIG. 6B and which were at least introduced previously herein. For example, related products, articles, and processes may be defined (block 136), different entry points in the value chain may be examined, and a real-win-worth score may be analyzed (block 138). Yet further, a priority score may be assigned based on market timing, product value, technology rating, strategic leveraging, etc. (block 140).

As shown in FIG. 6C, incremental product sequencing may also further be determined by documenting timing of key technology steps required to deliver product families in order of priority (block 142). In addition, such subsequent processing or analysis may provide the documentation of required process/technology elements for product platforms and relate such information to products and markets. One will recognize that various types of information and/or analysis and processing of information may occur with respect to subsequent steps relative to the completion of worksheets or other data recordation structures, and that the present invention is not limited to any particular subsequent processing step described herein.

FIGS. 14A-14C provide market, process, and article worksheets 300, 330, and 360 that have been partially completed to provide a sample of the analysis tools according to the present invention with regard to browser technology. As the rationale for completing such worksheets has previously been provided herein with reference to FIGS. 10-12, no further description with regard to the sample data is provided, as it is believed to be self-explanatory.

All patents and references cited herein are incorporated in their entirety as if each were incorporated separately. This invention has been described with reference to illustrative embodiments and is not meant to be construed in a limiting sense. As described previously, one skilled in the art will recognize that various other illustrative configurations for the analysis tools presented herein, as well as for use of the information provided through such tools, can be utilized in various combinations. Various modifications of the illustrative embodiments, as well as additional embodiments of the invention and combinations of various elements herein, will be apparent to persons skilled in the art upon reference to this description. It is therefore contemplated that the patented claims will cover any such modifications or embodiments that may fall within the scope of the present invention as defined by the accompanying claims.

What is claimed is:

1. A method for use in analysis of a field of interest, the method comprising:
providing two or more data recordation structures, wherein each of the two or more data recordation structures is configured to receive information, wherein each of the two or more data recordation structures corresponds to one of a plurality of topic categories related to the field of interest, and further wherein each of the two or more data recordation structures comprises:
a primary data description region for receiving a hierarchical structure of dominant and subservient descriptions related to the corresponding topic category,
a generational data description region for receiving information relating to an increasing level of advancement over time of one or more of the subservient descriptions in the hierarchical structure,
a differentiating data description region for receiving information relating to at least one or more differentiating attributes of subservient descriptions provided in the primary data description region and/or relating to at least one or more differentiating attributes of information provided in the generational data description region, and
a rating region for use in rating at least one or more characteristics of information in the differentiating data description region;
recording information for a first topic category in a first data recordation structure of the two or more data recordation structures, wherein the information for the first topic category comprises at least descriptions having a relationship that can be arranged in the hierarchical structure of the primary data description region thereof;
recording information for a second topic category in a second data recordation structure of the two or more data recordation structures based on information provided for the first topic category, wherein the information for the second topic category comprises at least descriptions having a relationship that can be arranged in the hierarchical structure of the primary data description region thereof; and
recording information in one or more of the generational data description regions, the differentiating data description regions, and the rating regions for one or more subservient descriptions recorded in the hierarchical structure of the first and second data recordation structures.

2. The method of claim 1, wherein the method further comprises using at least the first and second data recordation structures to generate a summary guide for the field of interest based at least on the ratings provided in the rating region of at least one of the first and second data recordation structures.

3. The method of claim 1, wherein each of the two or more data recordation structures is configured to receive information related to at least one of products, articles, or processes in the field of interest, wherein each of the two or more data recordation structures corresponds to one of a plurality of topic categories, wherein the plurality of topic categories comprise markets for products in the field of interest, articles in the field of interest, and processes related to the field of interest.

4. The method of claim 3, wherein providing two or more data recordation structures comprises providing three data recordation structures, wherein each of the at least three data recordation structures correspond to one of three topic categories including markets for products in the field of interest, articles in the field of interest, and processes related to the field of interest, respectively.

5. The method of claim 1, wherein portions of the differentiating data description region and the rating region for receiving information associated with one or more subservient descriptions are provided such that information received therein is located in proximity to the subservient description for which the information characterizes.

6. The method of claim 4, wherein each of the two or more data recordation structures is configured as a two dimensional array of cells arranged in columns and rows, and further wherein the portions of the differentiating data description region and the rating regions are provided such that information received therein is located within the same row or column as the subservient description for which the information characterizes.

7. The method of claim 1, wherein each of the two or more data recordation structures is configured as a two dimensional array of cells arranged in columns and rows, and further wherein the primary data description region for receiving a hierarchical structure of dominant and subservient descriptions related to the corresponding topic category is limited to use of three or less columns or rows in the two dimensional array.

8. The method of claim 1, wherein the method further comprises requiring population of the differentiating data description region with information relating to at least one or more differentiating attributes of subservient descriptions provided in the primary data description region and/or relating to at least one or more differentiating attributes of information in the generational data description region.

9. The method of claim 1, wherein the hierarchical structure of the primary data description region for at least one data recordation structure comprises dominant and multiple levels of subservient descriptions related to the corresponding topic category, the multiple levels of subservient descriptions comprising a most subservient description, and further wherein information relating to at least one or more differentiating attributes of the most subservient descriptions provided in the primary data description region and/or relating to at least one or more differentiating attributes of information provided in the generational data description region is provided in the differentiating data description region.

10. The method of claim 9, wherein providing two or more data recordation structures comprises providing at least a market data recordation structure, wherein the market data recordation structure is populated with industry, market, and client segment descriptions in a primary data description region of the market data recordation structure, wherein the client segment descriptions are the most subservient descriptions in the hierarchical structure.

11. The method of claim 10, wherein recording information in one or more of the generational data description region, the differentiating data description region, and the rating region comprises providing at least information of one or more potential products that may be introduced over time in the generational data description region of the markets data recordation structure.

12. The method of claim 10, wherein recording information in one or more of the generational data description region, the differentiating data description region, and the rating region comprises subjectively rating the overall degree of potential interest of clients based at least on the client segment descriptions in the primary data description region of the market data recordation structure and based on the information of one or more potential products that may be introduced over time in the generational data description region of the markets data recordation structure.

13. The method of claim 10, wherein recording information in one or more of the generational data description region, the differentiating data description region, and the rating region comprises:
providing at least information relating to at least one or more client differentiators or exciters indicative of a client need that relates to one or more of the most subservient descriptions in the hierarchical structure; and
rating one or more of the client differentiators or exciters.

14. The method of claim 9, wherein providing two or more data recordation structures comprises providing at least an article data recordation structure, wherein the article data recordation structure is populated with one or more family descriptions, one or more genus descriptions for each family, and one or more species descriptions for each family in a primary data description region of the article data recordation structure, wherein the species descriptions are the most subservient descriptions in the hierarchical structure.

15. The method of claim 14, wherein recording information in one or more of the generational data description region, the differentiating data description region, and the rating region comprises providing at least information of one or more potential articles that may be introduced over time in the generational data description region of the articles data recordation structure that relate to one or more of the most subservient descriptions in the hierarchical structure.

16. The method of claim 15, wherein recording information in one or more of the generational data description region, the differentiating data description region, and the rating region comprises:
providing at least information relating to at least one or more differentiating attributes concerning how an article of one or more of the potential articles is different from currently available articles or articles that may be presented by others in the future; and
subjectively rating one or more of the differentiating attributes with regard to the sustainability of the differentiating attributes over time relative to currently available articles or articles that may be presented by others in the future and/or the degree of differentiation of the differentiating attributes.

17. The method of claim 9, wherein providing two or more data recordation structures comprises providing at least a process data recordation structure, wherein the process data recordation structure is populated with function descriptions indicative of what functions one or more processes are to achieve, operation descriptions indicative of general groups of processes that can carry out such functions, and specific process descriptions indicative of transformation outcomes which fall within the general groups of processes, wherein the specific process descriptions are the most subservient descriptions in the hierarchical structure.

18. The method of claim 17, wherein recording information in one or more of the generational data description region, the differentiating data description region, and the rating region comprises providing at least information of one or more potential processes that may be introduced over time in the generational data description region of the process data recordation structure that relate to one or more of the most subservient descriptions in the hierarchical structure.

19. The method of claim 18, wherein recording information in one or more of the generational data description region, the differentiating data description region, and the rating region comprises:
providing at least information relating to at least one or more differentiating attributes concerning how a process of one or more of the potential processes is different from currently available processes or processes that may be presented by others in the future; and
subjectively rating one or more of the differentiating attributes with regard to the sustainability of the differentiating attributes over time relative to currently available process or processes that may be presented by others in the future and/or the degree of differentiation of the differentiating attributes.

20. The method of claim 1, wherein the method is a computer assisted method implemented using at least one computer apparatus.

21. The method of claim 20, wherein the two or more data recordation structures are implemented using multiple worksheets, wherein the method further comprises using at least the first and second data recordation structures to complete a summary worksheet for the field of interest based at least on the ratings provided in the rating region of at least one of the first and second data recordation structures, wherein at least the summary worksheet and one or more of the multiple worksheets are integrated for exchange of information therebetween.

22. The method of claim 1, wherein the method further comprises sorting descriptions in the hierarchical structure of the primary data description region of the first data recordation structure using ratings provided in the rating region of the first data recordation structure, and further wherein providing information for the second topic category comprises providing information based on the sorted descriptions of the first data recordation structure.

23. A method for use in analysis of a field of interest, the method comprising:
providing at least three data recordation structures, wherein each of the at least three data recordation structures correspond to one of at least three topic categories including markets for products in the field of interest, articles in the field of interest, and processes related to the field of interest, respectively, and further wherein each of the at least three data recordation structures comprises:
a primary data description region for receiving a hierarchical structure of dominant and one or more levels of subservient descriptions related to the corresponding topic category, the one or more levels of subservient descriptions comprising a most subservient description,
a generational data description region for receiving information relating to an increasing level of advancement over time of one or more of the most subservient descriptions in the hierarchical structure,
a differentiating data description region for receiving information relating to at least one or more differentiating attributes of the most subservient descriptions provided in the primary data description region and/or relating to at least one or more differentiating attributes of information provided in the generational data description region, and
a rating region for use in rating at least one or more characteristics of information in the differentiating data description region;
recording information for a first topic category in a first data recordation structure of the at least three data recordation structures, wherein the information for the first topic category comprises at least descriptions having a relationship that can be arranged in the hierarchical structure of the primary data description region thereof;
recording information for a second topic category in one or more other data recordation structures of the at least three data recordation structures based on information provided for the first topic category, wherein the information for the second topic category comprises at least descriptions having a relationship that can be arranged in the hierarchical structure of the primary data description region thereof;
recording at least information of one or more potential products that may be introduced over time in the generational data description region of the data recordation structure corresponding to the markets for products in the field of interest; and
subjectively rating the overall degree of potential interest of clients in the rating region of the data recordation structure corresponding to the markets for products in the field of interest based at least on the client descriptions in the primary data description region of the data recordation structure corresponding to the markets for products in the field of interest and based on the information of one or more potential products that may be introduced over time in the generational data description region of the data recordation structure corresponding to the markets for products in the field of interest.

24. The method of claim 23, wherein the method further comprises using at least the rating region of the data recordation structure corresponding to the markets for products in the field of interest to generate a summary guide for the field of interest.

25. The method of claim 23, wherein portions of the differentiating data description region and the rating region for receiving information associated with one or more subservient descriptions are provided such that information received therein is located in proximity to the subservient description for which the information characterizes.

26. The method of claim 25, wherein each of the two or more data recordation structures is configured as a two dimensional array of cells arranged in columns and rows, and further wherein the portions of the differentiating data description region and the rating regions are provided such that information received therein is located within the same row or column as the subservient description for which the information characterizes.

27. The method of claim 23, wherein each of the two or more data recordation structures is configured as a two dimensional array of cells arranged in columns and rows, and further wherein the primary data description region for receiving a hierarchical structure of dominant and subservient descriptions related to the corresponding topic category is limited to use of three or less columns or rows in the two dimensional array.

28. The method of claim 23, where the method further comprises requiring population of the differentiating data description region of at least one of the three data recordation structures with information relating to at least one or more differentiating attributes of the most subservient descriptions provided in the primary data description region and/or relating to at least one or more differentiating attributes of information in the generational data description region.

29. The method of claim 23, wherein providing at least three data recordation structures comprises providing at least a market data recordation structure corresponding to the markets for products in the field of interest, wherein the market data recordation structure is populated with industry, market, and client segment descriptions in a primary data description region of the market data recordation structure, wherein the client segment descriptions are the most subservient descriptions in the hierarchical structure.

30. The method of claim 29, wherein the method further comprises:
recording at least information relating to at least one or more client differentiators or exciters indicative of a client need that relates to one or more of the most subservient descriptions in the differentiating data description region of the market data recordation structure; and
rating one or more of the client differentiators or exciters.

31. The method of claim 23, wherein providing at least three data recordation structures comprises providing at least an article data recordation structure corresponding to articles in the field of interest, wherein the article data recordation structure is populated with one or more family descriptions, one or more genus descriptions for each family, and one or more species descriptions for each family in a primary data description region of the article data recordation structure, wherein the species descriptions are the most subservient descriptions in the hierarchical structure.

32. The method of claim 31, wherein the method further comprises providing at least information of one or more potential articles that may be introduced over time in the generational data description region of the articles data recordation structure that relate to one or more of the most subservient descriptions in the hierarchical structure.

33. The method of claim 32, wherein the method further comprises:
providing at least information relating to at least one or more differentiating attributes concerning how an article of one or more of the potential articles is different from currently available articles or articles that may be presented by others in the future; and
subjectively rating one or more of the differentiating attributes with regard to the sustainability of the differentiating attributes over time relative to currently available articles or articles that may be presented by others in the future and/or the degree of differentiation of the differentiating attributes.

34. The method of claim 23, wherein providing at least three data recordation structures comprises providing at least a process data recordation structure corresponding to processes related to the field of interest, wherein the process data recordation structure is populated with function descriptions indicative of what functions one or more processes are to achieve, operation descriptions indicative of general groups of processes that can carry out such functions, and specific process descriptions indicative of a transformation outcomes which fall within the general groups of processes, wherein the specific process descriptions are the most subservient descriptions in the hierarchical structure.

35. The method of claim 34, wherein the method further comprises providing at least information of one or more potential processes that may be introduced over time in the generational data description region of the process data recordation structure that relate to one or more of the most subservient descriptions in the hierarchical structure.

36. The method of claim 35, wherein the method further comprises:
providing at least information relating to at least one or more differentiating attributes concerning how a process of one or more of the potential processes is different from currently available processes or processes that may be presented by others in the future; and
subjectively rating one or more of the differentiating attributes with regard to the sustainability of the differentiating attributes over time relative to currently available process or processes that may be presented by others in the future and/or the degree of differentiation of the differentiating attributes.

37. The method of claim 23, wherein the method is a computer assisted method implemented using at least one computer apparatus.

38. The method of claim 23, wherein the at least three data recordation structures are implemented using multiple worksheets, wherein the method further comprises using at least one of the multiple worksheets to complete a summary worksheet for the field of interest based at least on the ratings provided in the rating region of the data recordation structure corresponding to the markets for products in the field of interest, wherein at least the summary worksheet and worksheet implementing the data recordation structure corresponding to the markets for products in the field of interest are integrated for exchange of information therebetween.

39. A system to collect information for use in analysis of a field of interest, the system comprising two or more data recordation structures, wherein each of the two or more data recordation structures is configured to receive information, wherein each of the two or more data recordation structures corresponds to one of a plurality of topic categories related to the field of interest, and further wherein each of the two or more data recordation structures comprises:
a primary data description region configured to request a hierarchical structure of dominant and subservient descriptions related to the corresponding topic category;
a generational data description region configured to request information relating to an increasing level of advancement over time of one or more of the subservient descriptions in the hierarchical structure;
a differentiating data description region configured to request information relating to at least one or more differentiating attributes of subservient descriptions provided in the primary data description region and/or relating to at least one or more differentiating attributes of information provided in the generational data description region; and
a rating region configured to request ratings for at least one or more characteristics of information in the differentiating data description region.

40. The system of claim 39, wherein the system further comprises a summary guide for the field of interest configured to be completed based at least on the ratings provided in the rating region of at least one of the first and second data recordation structures.

41. The system of claim 39, wherein each of the two or more data recordation structures is configured to receive information related to at least one of products, articles, or processes in the field of interest, wherein each of the two or more data recordation structures corresponds to one of a plurality of topic categories, and further wherein the plurality of topic categories comprise markets for products in the field of interest, articles in the field of interest, and processes related to the field of interest.

42. The system of claim 39, wherein the two or more data recordation structures comprise three data recordation structures, wherein each of the three data recordation structures correspond to one of three topic categories including markets for products in the field of interest, articles in the field of interest, and processes related to the field of interest, respectively.

43. The system of claim 39, wherein portions of the differentiating data description region and the rating region for receiving information associated with one or more subservient descriptions are provided such that information received therein is located in proximity to the subservient description for which the information characterizes.

44. The system of claim 43, wherein each of the two or more data recordation structures is configured as a two dimensional array of cells arranged in columns and rows, and further wherein the portions of the differentiating data description region and the rating regions are provided such that information received therein is located within the same row or column as the subservient description for which the information characterizes.

45. The system of claim 39, wherein each of the two or more data recordation structures is configured as a two dimensional array of cells arranged in columns and rows, and further wherein the primary data description region for receiving a hierarchical structure of dominant and subservient descriptions related to the corresponding topic category is limited to use of three or less columns or rows in the two dimensional array.

46. The system of claim 39, where the system requires population of the differentiating data description region with information relating to at least one or more differentiating attributes of subservient descriptions provided in the primary data description region and/or relating to at least one or more differentiating attributes of information in the generational data description region.

47. The system of claim 39, wherein the hierarchical structure of the primary data description region for at least one data recordation structure is configured to request dominant and multiple levels of subservient descriptions related to the corresponding topic category, the multiple levels of subservient descriptions comprising a most subservient description, and further wherein the generational data description region is configured to request information relating to an increasing level of advancement over time of one or more of the most subservient descriptions in the hierarchical structure.

48. The system of claim 47, wherein the two or more data recordation structures comprise a market data recordation structure configured to request information regarding industry, market, and client segment descriptions in a primary data description region thereof, wherein the client segment descriptions are the most subservient descriptions in the hierarchical structure.

49. The system of claim 48, wherein the generational data description region of the market data recordation structure is configured to request information of one or more potential products that may be introduced over time.

50. The system of claim 48, wherein the rating region of the market data recordation structure is configured to request a subjective rating of the overall degree of potential interest of clients based at least on the client segment descriptions in the primary data description region of the market data recordation structure and based on the information of one or more potential products that may be introduced over time in the generational data description region of the markets data recordation structure.

51. The system of claim 48, wherein the differentiating data description region of the market data recordation structure is configured to request information relating to at least one or more client differentiators or exciters indicative of a client need that relates to one or more of the most subservient descriptions in the hierarchical structure, and wherein the rating region of the market data recordation structure is configured to request ratings for one or more of the client differentiators or exciters.

52. The system of claim 47, wherein the two or more data recordation structures comprise an article data recordation structure configured to request one or more family descriptions, one or more genus descriptions for each family, and one or more species descriptions for each family in a primary data description region of the article data recordation structure, wherein the species descriptions are the most subservient descriptions in the hierarchical structure.

53. The system of claim 52, wherein the generational data description region of the articles data recordation structure is configured to request information of one or more potential articles that may be introduced over time that relate to one or more of the most subservient descriptions in the hierarchical structure.

54. The system of claim 53, wherein the differentiating data description region of the articles data recordation structure is configured to request information relating to at least one or more differentiating attributes concerning how an article of one or more of the potential articles is different from currently available articles or articles that may be presented by others in the future, and wherein the rating region of the articles data recordation structure is configured to request ratings for one or more of the differentiating attributes with regard to the sustainability of the differentiating attributes over time relative to currently available articles or articles that may be presented by others in the future and/or the degree of differentiation of the differentiating attributes.

55. The system of claim 47, wherein the two or more data recordation structures comprise a process data recordation structure configured to request function descriptions indicative of what functions one or more processes are to achieve, operation descriptions indicative of general groups of processes that can carry out such functions, and specific process descriptions indicative of transformation outcomes which fall within the general groups of processes, wherein the specific process descriptions are the most subservient descriptions in the hierarchical structure.

56. The system of claim 55, wherein the generational data description region of the process data recordation structure is configured to request information of one or more potential processes that may be introduced over time that relate to one or more of the most subservient descriptions in the hierarchical structure.

57. The system of claim 56, wherein the differentiating data description region of the process data recordation structure is configured to request information relating to at least one or more differentiating attributes concerning how a process of one or more of the potential processes is different from currently available processes or processes that may be presented by others in the future, and wherein the rating region of the process data recordation structure is configured to request ratings for one or more of the differentiating attributes with regard to the sustainability of the differentiating attributes over time relative to currently available process or processes that may be presented by others in the future and/or the degree of differentiation of the differentiating attributes.

58. The system of claim 39, wherein the system comprises at least one computer apparatus.

59. The system of claim 39, wherein the two or more data recordation structures are implemented using multiple worksheets, wherein the summary guide for the field of interest is completed using the multiple worksheets, wherein at least the summary worksheet and one or more of the multiple worksheets are integrated for exchange of information therebetween.

60. The system of claim 39, wherein the system comprises means for sorting descriptions in the hierarchical structure of the primary data description region of at least one of the two or more data recordation structures using ratings provided in the rating regions thereof.

61. A storage device readable by machine for use in performing a method of analysis of a field of interest, comprising two or more data recordation structures, wherein each of the two or more data recordation structures is configured to receive information, wherein each of the two or more data recordation structures corresponds to one of a plurality of topic categories related to the field of interest, and further wherein each of the two or more data recordation structures comprises:
a primary data description region configured to request a hierarchical structure of dominant and subservient descriptions related to the corresponding topic category;
a generational data description region configured to request information relating to an increasing level of advancement over time of one or more of the subservient descriptions in the hierarchical structure;
a differentiating data description region configured to request information relating to at least one or more differentiating attributes of subservient descriptions provided in the primary data description region and/or relating to at least one or more differentiating attributes of information provided in the generational data description region; and
a rating region configured to request ratings for at least one or more characteristics of information in the differentiating data description region.

62. The storage device of claim 61, wherein each of the two or more data recordation structures is configured to receive information related to at least one of products, articles, or processes in the field of interest, wherein each of the two or more data recordation structures corresponds to one of a plurality of topic categories, and further wherein the plurality of topic categories comprise markets for products in the field of interest, articles in the field of interest, and processes related to the field of interest.

63. The storage device of claim 61 readable by machine, and tangibly embodying a program of instructions executable by the machine to provide a summary guide for the field of interest configured to be completed using at least two or more data recordation structures based at least on the ratings provided in the rating region of at least the two or more data recordation structures.
